(19) United States
(12) Patent Application Publication
(10) Pub. No.: US 2021/0038025 A1
(43) Pub. Date: Feb. 11, 2021

(54) AUTOMATED FRYER SYSTEM WITH A DELAMINATING FOOD DISPENSING SYSTEM

(71) Applicant: Robert Almblad, Lynchburg, VA (US)

(72) Inventor: Robert Almblad, Lynchburg, VA (US)

(21) Appl. No.: 16/920,678

(22) Filed: Jul. 4, 2020

Related U.S. Application Data
(63) Continuation of application No. PCT/US2019/012594, filed on Jan. 8, 2019.
Application No. PCT/US2019/012594 is a continuation-in-part of application No. PCT/US2018/063955, filed on Dec. 5, 2018.
(60) Provisional application No. 62/633,745, filed on Feb. 22, 2018.
(60) Provisional application No. 62/614,536, filed on Jan. 8, 2018.
(60) Provisional application No. 62/615,154, filed on Jan. 9, 2018.
(60) Provisional application No. 62/787,346, filed on Jan. 1, 2019.

(51) Int. Cl. A47J 37/12; B25J 9/02; B25J 9/10; B25J 15/02; B25J 15/00

(52) U.S. Cl. CPC A47J 37/1228; A47J 37/1219; A47J 37/1266; A47J 37/1295; B25J 15/0033; B25J 9/026; B25J 9/104; B25J 15/0233; A47J 37/1276

(57) ABSTRACT

An automatic fryer system includes a fry basket; a fryer unit having a fry vat for housing heated cooking oil and receiving the fry basket; the fryer unit including a rear wall having a fry basket hooking member located thereon for parking the fry basket; a horizontal drive system for moving the fry basket in a horizontal direction; a vertical drive system, operatively connected to the horizontal drive system, for moving the fry basket in a vertical direction; an end effector for grasping and holding the fry basket; a food product loading unit for loading food product into the fry basket; and a controller, in operational communication with the horizontal drive system; the vertical drive system, and the end effector, to control a location and an orientation of the fry basket.

### PRIORITY INFORMATION

The present application is a continuation application of PCT Patent Application Number PCT/US2019/012594, filed on Jan. 8, 2019, and claims priority, under 35 U.S.C. § 120 and Article 8 of the Patent Cooperation Treaty, from PCT Patent Application Number PCT/US2019/012594, filed on Jan. 8, 2019; said PCT Patent Application Number PCT/US2019/012594, filed on Jan. 8, 2019, being a continuation-in-part of PCT Patent Application Number PCT/US2018/63955, filed on Dec. 5, 2018, and claiming priority, under 35 U.S.C. § 120, from PCT Patent Application Number PCT/US2018/063955, filed on Dec. 5, 2018; said PCT Patent Application Number PCT/US2018/063955, filed on Dec. 5, 2018, claiming priority, under 35 USC § 119(e), from U.S. Provisional Patent Application No. 62/633,745, filed on Feb. 22, 2018. The entire content of PCT Patent Application Number PCT/US2019/012594, filed on Jan. 8, 2019, is hereby incorporated by reference. The entire content of PCT Patent Application Number PCT/US2018/063955, filed on Dec. 5, 2018, is hereby incorporated by reference.

The present application claims priority, under 35 U.S.C. § 119(e), from U.S. Provisional Patent Application No. 62/633,745, filed on Feb. 22, 2018. The entire content of U.S. Provisional Patent Application No. 62/633,745, filed on Feb. 22, 2018, is hereby incorporated by reference.

The present application claims priority, under 35 U.S.C. § 119(e), from U.S. Provisional Patent Application, Ser. No. 62/614,536, filed on Jan. 8, 2018. The entire content of U.S. Provisional Patent Application, Ser. No. 62/614,536, filed on Jan. 8, 2018, is hereby incorporated by reference.

The present application claims priority, under 35 U.S.C. § 119(e), from U.S. Provisional Patent Application, Ser. No. 62/615,154, filed on Jan. 9, 2018. The entire content of U.S. Provisional Patent Application, Ser. No. 62/615,154, filed on Jan. 9, 2018, is hereby incorporated by reference.

The present application claims priority, under 35 U.S.C. § 119(e), from U.S. Provisional Patent Application, Ser. No. 62/787,346, filed on Jan. 1, 2019. The entire content of U.S. Provisional Patent Application, Ser. No. 62/787,346, filed on Jan. 1, 2019, is hereby incorporated by reference.

### BACKGROUND

In restaurants, especially quick service (fast food) restaurants, fast, consistent, efficient, and safe food preparation is essential for a successful operation. The quality of the prepared food depends in large part on the consistency of food preparation. The food must be cooked under correct conditions for the proper time.

Consistency in food preparation can vary as a result of many factors. For example, people engaged in food preparation often must perform multiple tasks at frequencies that vary with time because of constantly varying customer demand throughout the day. Specifically, lunchtime and dinnertime may be extremely busy while other periods may be relatively slow. The product mix can vary from hour to hour and day to day. As a result, the consistency and quality of food may vary. Difficulties in proper scheduling of food production during peak and non-peak periods can cause customer delays and/or stale, wasted or unusable food.

Food preparation can be labor intensive, and thus, the labor cost can be a large portion of the total cost of the prepared food. An additional problem is that in sparsely populated and other areas where quick service restaurants are located, such as along interstate highways, for example, recruiting sufficient numbers of suitable employees is difficult.

Accordingly, a need exists for an automated, commercially suitable food dispensing, cooking, and packaging system for fried foods that can be operated with a minimum of human intervention, control, and maintenance.

Although automated fryers are now available for cooking food, such as french fries, under computer-controlled conditions, the operation used in most fast food chain restaurants uses manual labor to carry out a large part of the operation.

In the typical operation, frying baskets are manually filled with pre-cut, partially cooked (parfried) strips of potatoes away from the fryer, and subsequently loaded onto a slack rack. When the operator wishes to cook the potatoes, a basket is manually removed from the slack rack and inserted into the basket lift arm of the fryer. The start button is pressed on the computer-controlled fryer, and the basket lift arm lowers the basket into the preheated shortening.

At the end of the cook cycle, the baskets are automatically raised by the lift arm out of the shortening. The baskets are then allowed to remain in a position above the fryer so that excess oil will drip back into the fryer. The fried potatoes are then brought to a holding station, and emptied in the holding station.

An example of an automated fryer system for fried potatoes is disclosed in U.S. Pat. No. 5,142,968. More specifically, U.S. Pat. No. 5,142,968 discloses an automated system for storing and cooking fried potatoes includes a refrigeration and storage assembly and unique transport system which is easily used with fryers of a commercial type. The transport system includes a horizontal and vertical transport assembly for moving baskets of fries to and from the one or more fryers, with the vertical transport assembly being adapted to lower the basket into the fryer as well as support the basket above the fryer after cooking so as to allow the basket to drain. The entire content of U.S. Pat. No. 5,142,968 is hereby incorporated by reference.

Another example of an automated fryer system for fried potatoes is disclosed in U.S. Pat. No. 5,230,279. More specifically, U.S. Pat. No. 5,230,279 discloses a system for storing and automatically dispensing predetermined amounts of one or more food products from closed containers. The system includes multi-compartment containers carried by a carousel assembly and moved by a dispensing mechanism for automatically selecting the appropriate container and compartment for which food is dispensed. The entire content of U.S. Pat. No. 5,230,279 is hereby incorporated by reference.

A further example of an automated fryer system for fried potatoes is disclosed in U.S. Pat. No. 7,343,719. More specifically, U.S. Pat. No. 7,343,719 discloses an automated food processing system that allows food to be dispensed, fried, and packaged in a suitable container, which may be an individual portion-sized container. The system includes separate automated modules for dispensing, frying, and packaging the food. The automated dispensing device dispenses a predetermined portion of food from a bulk storage container or food dispensing magazine. Food is dispensed to an automated fry device that can include at least one circular fry wheel having a plurality of food containing compartments. After the food is fried, it is dispensed from the fry device to an automated packaging device.

The automated packaging device dispenses food to a container that may be an individual portion-sized container that is retrieved, erected, and held into position for filling by an automated container handling system. The entire content of U.S. Pat. No. 7,343,719 is hereby incorporated by reference.

In addition to the conventional automated fryers disclosed above, there is a large amount of activity in the general field of restaurant automation in context of hygienic handling of various food product(s). Protocols such as lamination, sheet-layering, foil packaging and peeling off, dismantling and delamination, at the manufacture sites (food processing factories/units) and usage sites (restaurants, hotels, and eating points) are known.

In a conventional delamination of a laminate, conveyor belts are used to transport laminated food products from one place to other. Moreover, stripper units are used for unpacking the laminated food products such as peeling of film, delamination of laminated food. However, these conventional systems do not eliminate the need of human interference such as the food product directly passed on to a cooking unit.

For example, U.S. Pat. No. 5,141,584 discloses an apparatus and method for delaminating a composite sheet structure of the kind comprising a vertically frangible layer having a first surface adhesively bonded to a first sheet at a substantially uniform strength and an opposite surface abutting areas which are, respectively, adhesively bonded to a second sheet at strengths less or greater than the uniform strength and having a marginal portion or tab extending beyond the first sheet. The composite sheet structure is fed into the nip of upper and lower peel rollers and upon passage therethrough a strip sheet roller is rotated into position to bend and hold the laminate against the upper peel roller in a position to fracture the tab from the first sheet. On reversal of the feed direction and passage of the laminate back through the nip of the strip sheet and upper peel rollers, the thicker “keeper sheet” of the flexed laminate breaks from the “throw-away” sheet containing the tab at the preformed tab. A roller configuration and drive train structure are provided that provides a more predictable and repeatable steady state condition and allows for control of the location of the peel point to be accomplished. The entire content of U.S. Pat. No. 5,141,584 is hereby incorporated by reference.

Another conventional system is a method and device for packaging or unpackaging portions of a deep frozen food product. The conventional system packs portions of a low temperature foodstuff with longitudinal separations in a row behind one another. The portions are guided between two strips of foil packaging which are then combined in order to form a ribbon. The portions may be placed in chambers in one of the strips, which are arranged along it with equal spacings. Each strip may also have half-chambers, and may be guided together in order to align corresponding half-chambers with each other prior to the introduction of a portion into one or both of them.

The features of the discussed prior art disclose complex design and bulky structural indices, thereby hindering utilization in restaurant automation devices. Moreover, the discussed prior art fails to address the use of restaurant automation in highly aseptic conditions by eliminating human interference during transfer of food products from refrigerated storage to cooking unit.

Therefore, it is desirable to provide a system that enables the automation of a fryer system which minimizes human interaction and provides an efficient and consistent cooking process.

### BRIEF DESCRIPTION OF THE DRAWING

The drawings are only for purposes of illustrating various embodiments and are not to be construed as limiting, wherein:

FIG. 1 illustrates an automated frying system;

FIG. 2 illustrates the automated frying system preparing to pick up a first fry basket;

FIG. 3 illustrates the automated frying system engaging the first fry basket;

FIG. 4 illustrates the automated frying system lifting the empty first fry basket;

FIG. 5 illustrates the automated frying system filling the first fry basket with a first food product;

FIG. 6 illustrates the automated frying system transporting the first food product filled first fry basket to a first frying vat;

FIG. 7 illustrates the automated frying system placing the first food product filled first fry basket into the first frying vat;

FIG. 8 illustrates the automated frying system preparing to start a new frying cycle;

FIG. 9 illustrates the automated frying system engaging a second fry basket;

FIG. 10 illustrates the automated frying system filling the second fry basket with a second food product;

FIG. 11 illustrates the automated frying system placing the second food product filled second fry basket into a second frying vat;

FIG. 12 illustrates the automated frying system lifting the first fry basket filled with fried first food product;

FIG. 13 illustrates the automated frying system emptying the first fry basket of the fried first food product into a first receiving bin;

FIG. 14 illustrates the automated frying system after placing the emptied first fry basket into the first frying vat;

FIG. 15 illustrates the automated frying system lifting the second fry basket filled with fried second food product;

FIG. 16 illustrates the automated frying system emptying the second fry basket of the fried second food product into a second receiving bin;

FIG. 17 illustrates an example of another embodiment of an automated frying system;

FIG. 18 illustrates an example of a delaminating food dispensing system for an automated frying system;

FIG. 19 illustrates a food dispensing module for a delaminating food dispensing system;

FIG. 20 illustrates a bottom dispensing food dispensing module for a delaminating food dispensing system;

FIG. 21 illustrates a top dispensing food dispensing module for a delaminating food dispensing system;

FIG. 22 illustrates a food dispensing module within a delaminating food dispensing system;

FIG. 23 illustrates an end effector for grasping and securing a fryer basket for transportation and rotation;

FIG. 24 illustrates a block diagram of the automated frying system;

FIG. 25 illustrates an enclosure for the automated frying system;

FIG. 26 Illustrates a conventional seal for laminated food products;

FIG. 27 Illustrates a seal for laminated food products;

FIG. 28 illustrates another embodiment of a seal for laminated food products;

FIG. 29 illustrates a dimensional relationship for the conventional seal of FIG. 26;

FIG. 30 illustrates a dimensional relationship for the seal of FIG. 27; and

FIG. 31 illustrates a dimensional relationship for the seal of FIG. 28.

### DETAILED DESCRIPTION OF THE DRAWINGS

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts could be properly illustrated.

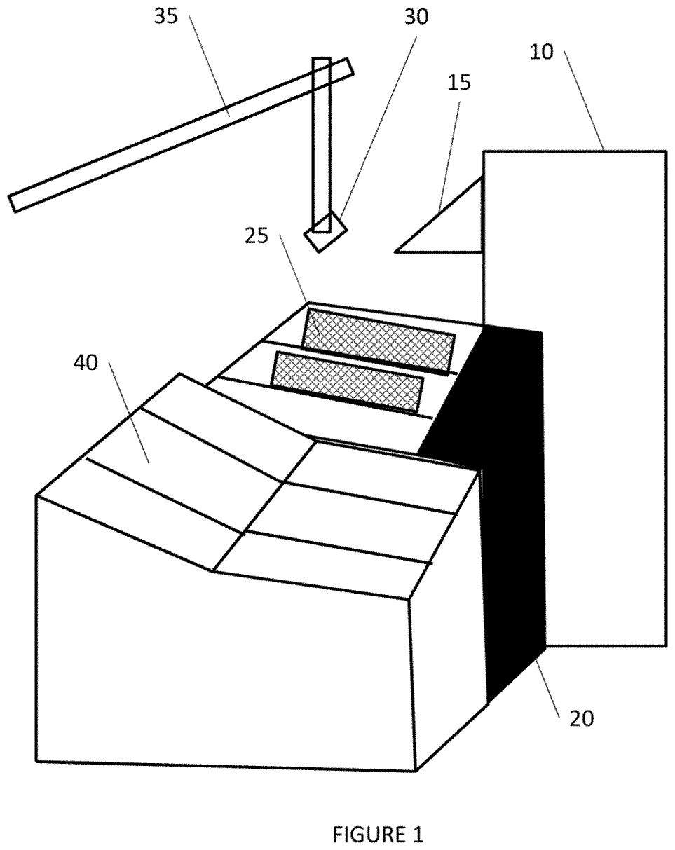

FIG. 1 illustrates an automated frying system. As illustrated in FIG. 1, the automated frying system includes a food storage/dispensing unit 10 for storing food to be fried in the frying system. The food stored in the food storage/dispensing unit 10 is dispensed from a dispensing shoot 15. The food storage/dispensing unit 10 may a system to keep internal temperatures below freezing if the food to be fried is frozen food, or the food storage/dispensing unit 10 may a system to keep internal temperatures just above freezing if the food to be fried is not frozen, but needs to be kept cold or cool.

The automated frying system further includes a fry system 20 and a plurality of fry baskets 25. The fry system 20 includes multiple individual and independent fry vat to allow the frying of different foods with cross contamination and to fry foods at different temperatures. The fry system 20 may include various controllers to maintain the proper frying temperatures.

The automated frying system includes a basket transport system having a horizontal track 35 and a vertically movable arm 30 that includes an end effector at the end of the vertically movable arm 30 that engages the fry basket 25. The end effector will be described in more detail below with respect to FIG. 27.

As illustrated in FIG. 1, the vertically movable arm 30 is parked in front of the food storage/dispensing unit 10. The basket transport system includes various processors, controllers, and motors to movement of the various fry baskets 25 between the various stations or systems.

In addition, the automated frying system includes a prep station 40 where the fried food is deposited and held until it is properly packaged for distributing to the customer.

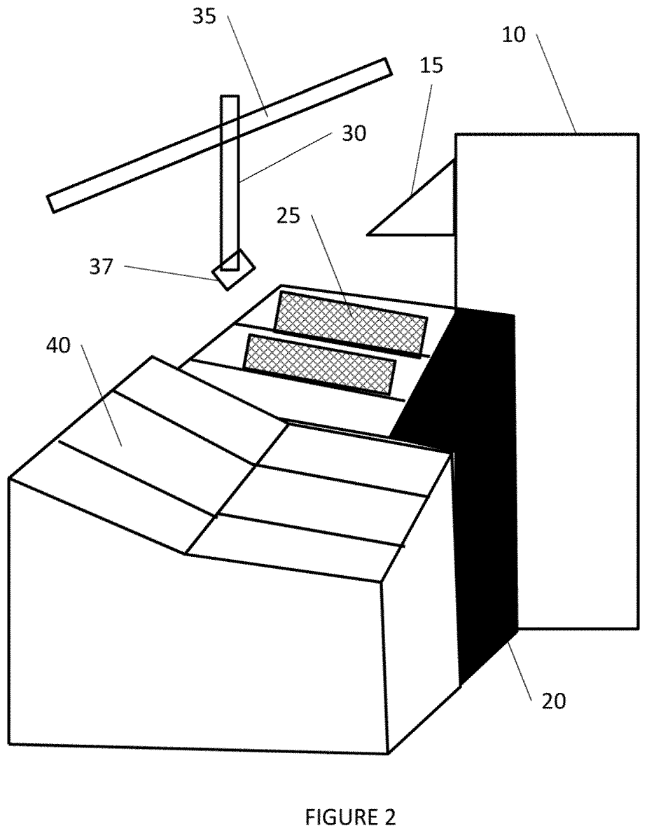

FIG. 2 illustrates the automated frying system preparing to pick up a first fry basket. As illustrated in FIG. 2, the various processors, controllers, and motors of the basket transport system cause the vertically movable arm 30 to move horizontally, along the horizontal track 35, from being parked in front of the food storage/dispensing unit 10 to being over a fry basket 25 located in a fry vat of the frying system 20.

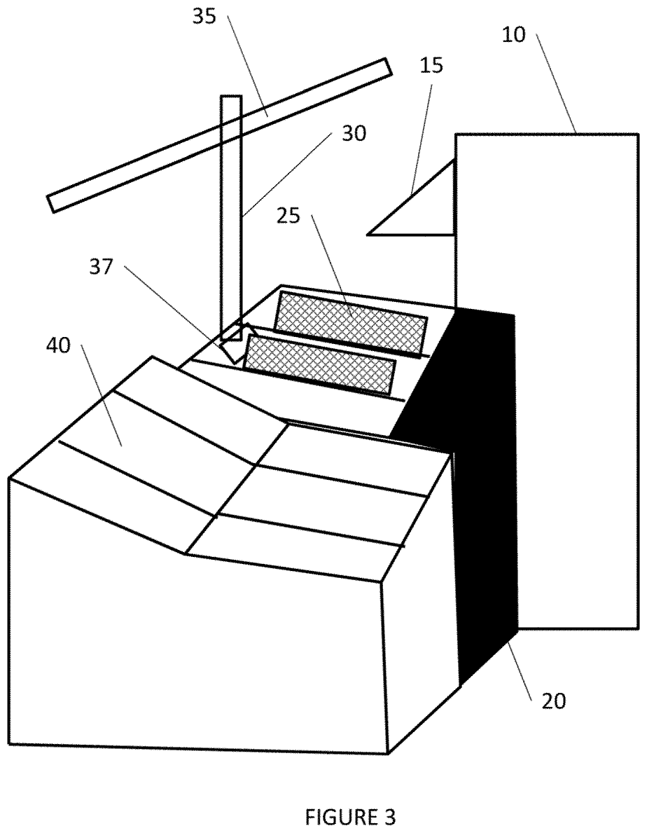

FIG. 3 illustrates the automated frying system engaging the first fry basket. As illustrated in FIG. 2, the various processors, controllers, and motors of the basket transport system cause the vertically movable arm 30 to move vertically towards the fry basket 25 located in a fry vat of the frying system 20. The movement of the vertically movable arm 30 may be a telescopic movement of the vertically movable arm 30. Upon engaging the fry basket 25 located in a fry vat of the frying system 20, the end effector 37 grasps or clamps the fry basket 25.

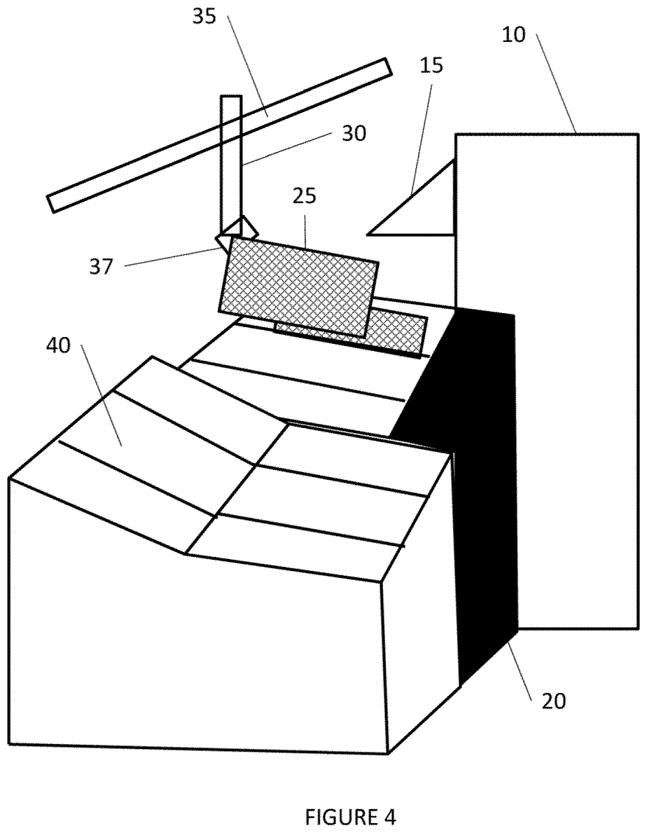

FIG. 4 illustrates the automated frying system lifting the empty first fry basket. As illustrated in FIG. 4, upon the end effector 37 grasping or clamping the fry basket 25, the vertically movable arm 30 moves, by various processors, controllers, and motors of the basket transport system, vertically away from the fry vat of the frying system 20, thereby lifting the fry basket 25 out of the fry vat of the frying system 20. The basket transport system may allow the fry basket 25 to remain in that parked position for a predetermined amount of time to allow any excess frying oil to drip from the fry basket 25 back into the fry vat of the frying system 20.

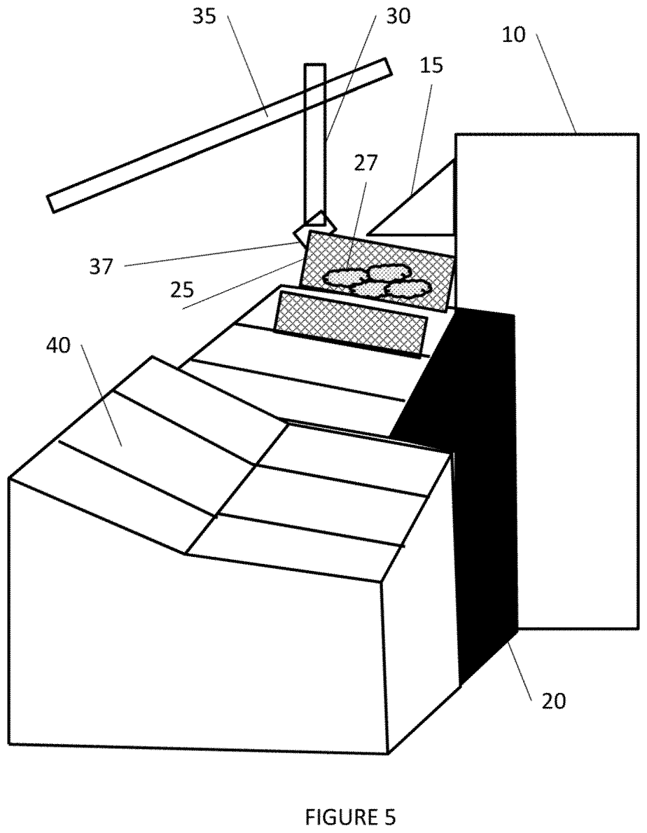

FIG. 5 illustrates the automated frying system filling the first fry basket with a first food product. As illustrated in FIG. 5, the various processors, controllers, and motors of the basket transport system cause the vertically movable arm 30 with the grasped fry basket 25 to move horizontally, along the horizontal track 35, from being parked over the fry vat of the frying system 20 to the front of the food storage/dispensing unit 10. In this loading position, the food storage/dispensing unit 10, as illustrated, dispenses, through the dispensing shoot 15, a first food product to be fried in the fry system 20 into a first fry basket 25.

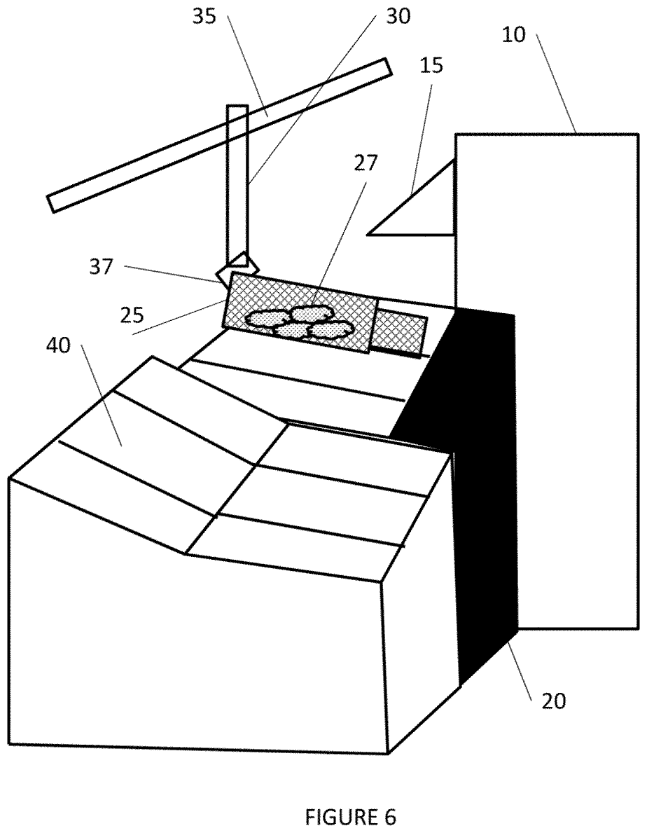

FIG. 6 illustrates the automated frying system transporting the first food product filled first fry basket to a first frying vat. As illustrated in FIG. 6, after the food storage/dispensing unit 10 has dispensed, through the dispensing shoot 15, the first food product to be fried in the fry system 20 into a first fry basket 25, the various processors, controllers, and motors of the basket transport system cause the vertically movable arm 30 with the grasped first food product filled fry basket 25 to move horizontally, along the horizontal track 35, from being parked in front of the food storage/dispensing unit 10 to a location over the appropriate fry vat of the frying system 20.

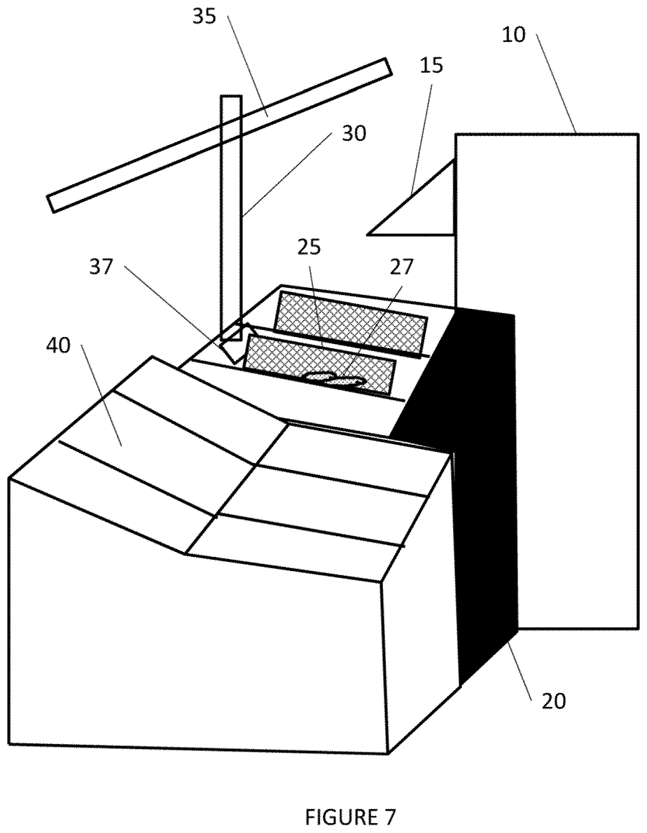

FIG. 7 illustrates the automated frying system placing the first food product filled first fry basket into the first frying vat. As illustrated in FIG. 7, upon locating the grasped first food product filled fry basket 25 over the appropriate fry vat of the frying system 20, the various processors, controllers, and motors of the basket transport system cause the vertically movable arm 30 with the grasped first food product filled fry basket 25 to move vertically so as to deposit the fry basket 25 into the appropriate fry vat of the frying system 20. Once the grasped first food product filled fry basket 25 is located in the appropriate fry vat of the frying system 20, the end effector 37 releases the fry basket 25.

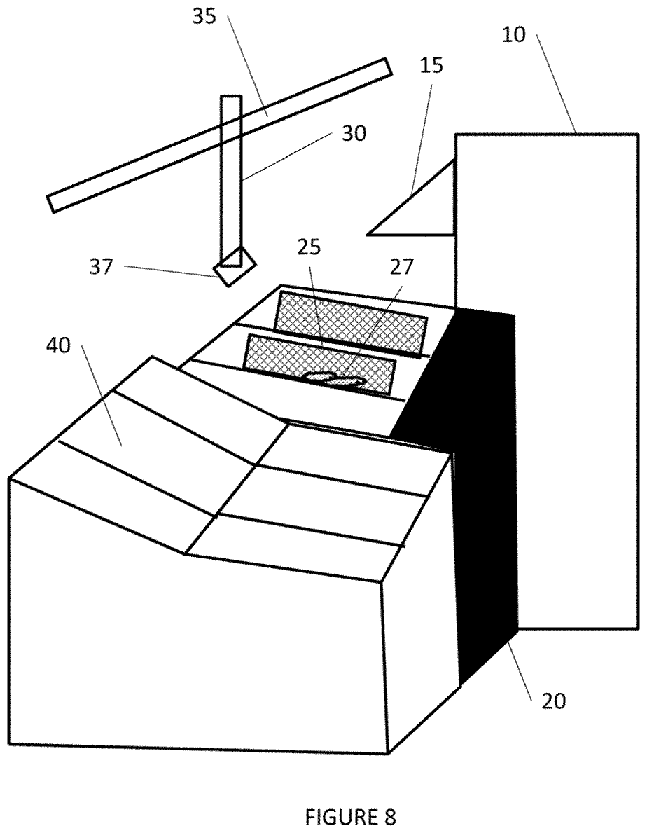

FIG. 8 illustrates the automated frying system preparing to start a new frying cycle. As illustrated in FIG. 8, upon the end effector 37 releasing the fry basket 25, the various processors, controllers, and motors of the basket transport system cause the vertically movable arm 30 to move vertically away from the fry vat so that the system can begin to fry another food product.

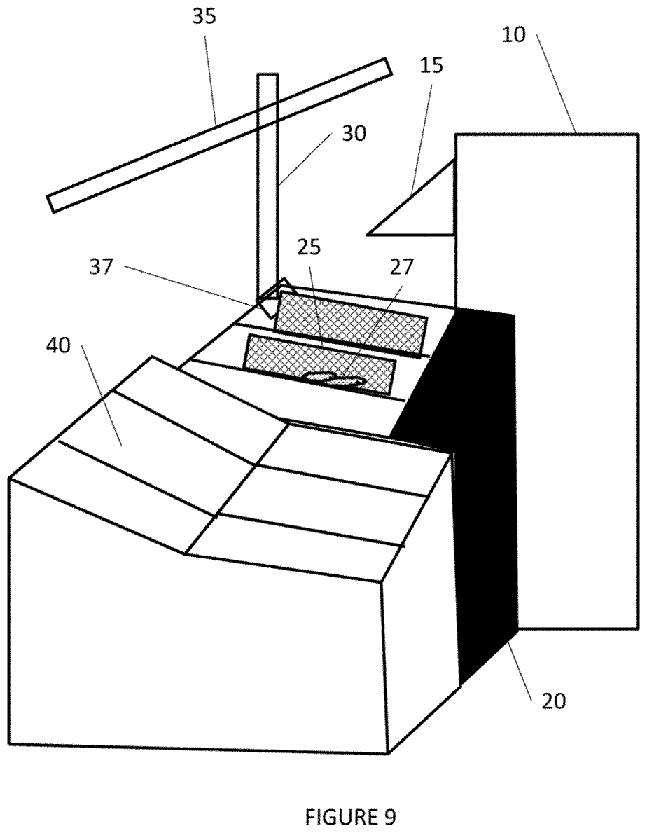

FIG. 9 illustrates the automated frying system engaging a second fry basket. As illustrated in FIG. 9, the various processors, controllers, and motors of the basket transport system cause the vertically movable arm 30 to move horizontally so that the vertically movable arm 30 is located over a second fry vat of the frying system 20. The various processors, controllers, and motors of the basket transport system then cause the vertically movable arm 30 to move vertically towards a second fry basket 25 located in the second fry vat of the frying system 20.

The vertical movement of the vertically movable arm 30 may be a telescopic movement of the vertically movable arm 30. Upon engaging the second fry basket 25 located in the second fry vat of the frying system 20, the end effector 37 grasps or clamps the second fry basket 25.

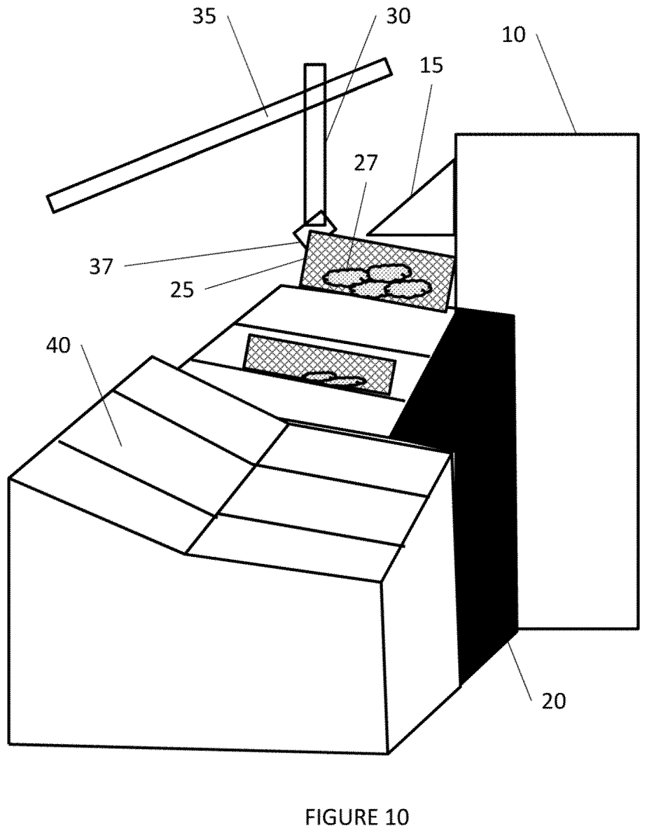

FIG. 10 illustrates the automated frying system filling the second fry basket with a second food product. As illustrated in FIG. 10, upon the end effector 37 grasping or clamping the second fry basket 25, the vertically movable arm 30 moves, by various processors, controllers, and motors of the basket transport system, vertically away from the second fry vat of the frying system 20, thereby lifting the second fry basket 25 out of the second fry vat of the frying system 20.

The basket transport system may allow the second fry basket 25 to remain in that parked position for a predetermined amount of time to allow any excess frying oil to drip from the second fry basket 25 back into the second fry vat of the frying system 20.

As further illustrated in FIG. 10, the various processors, controllers, and motors of the basket transport system cause the vertically movable arm 30 with the grasped second fry basket 25 to move horizontally, along the horizontal track 35, from being parked over the second fry vat of the frying system 20 to the front of the food storage/dispensing unit 10. In this loading position, the food storage/dispensing unit 10, as illustrated, dispenses, through the dispensing shoot 15, a second food product to be fried in the fry system 20 into the second fry basket 25.

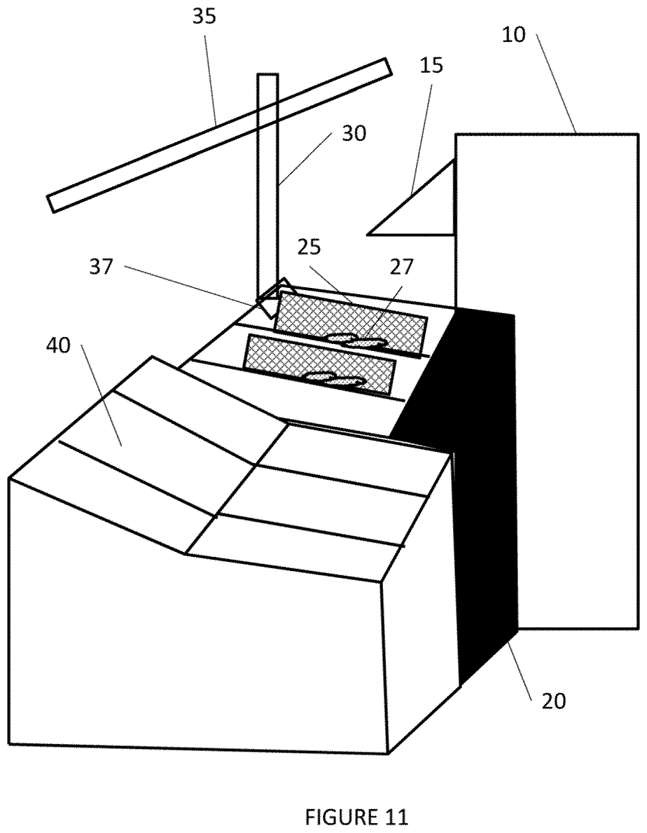

FIG. 11 illustrates the automated frying system placing the second food product filled second fry basket into a second frying vat. As illustrated in FIG. 11, after the food storage/dispensing unit 10 has dispensed, through the dispensing shoot 15, the second food product to be fried in the fry system 20 into the second fry basket 25, the various processors, controllers, and motors of the basket transport system cause the vertically movable arm 30 with the grasped second food product filled fry basket 25 to move horizontally, along the horizontal track 35, from being parked in front of the food storage/dispensing unit 10 to a location over the appropriate (second) fry vat of the frying system 20.

As illustrated in FIG. 11, upon locating the grasped second food product filled fry basket 25 over the appropriate (second) fry vat of the frying system 20, the various processors, controllers, and motors of the basket transport system cause the vertically movable arm 30 with the grasped second food product filled fry basket 25 to move vertically so as to deposit the second fry basket 25 into the appropriate (second) fry vat of the frying system 20. Once the grasped second food product filled fry basket 25 is located in the appropriate (second) fry vat of the frying system 20, the end effector 37 releases the second fry basket 25.

Although the various Figures, described above, illustrated a two basket system, the automated frying system may engage a third fry basket. In such an embodiment, upon the end effector releasing the second fry basket, the various processors, controllers, and motors of the basket transport system cause the vertically movable arm to move vertically away from the second fry vat so that the system can begin to fry another food product.

In this embodiment, the various processors, controllers, and motors of the basket transport system cause the vertically movable arm to move horizontally so that the vertically movable arm is located over a third fry vat of the frying system. The various processors, controllers, and motors of the basket transport system then cause the vertically movable arm to move vertically towards a third fry basket located in the third fry vat of the frying system.

The vertical movement of the vertically movable arm may be a telescopic movement of the vertically movable arm. Upon engaging the third fry basket located in the third fry vat of the frying system, the end effector grasps or clamps the third fry basket.

Upon the end effector grasping or clamping the third fry basket, the vertically movable arm moves, by various processors, controllers, and motors of the basket transport system, vertically away from the third fry vat of the frying system, thereby lifting the third fry basket out of the third fry vat of the frying system.

The basket transport system may allow the third fry basket to remain in that parked position for a predetermined amount of time to allow any excess frying oil to drip from the third fry basket back into the third fry vat of the frying system.

The various processors, controllers, and motors of the basket transport system cause the vertically movable arm with the grasped third fry basket to move horizontally, along the horizontal track, from being parked over the third fry vat of the frying system to the front of the food storage/dispensing unit. In this loading position, the food storage/dispensing unit dispenses, through the dispensing shoot, a third food product to be fried in the fry system into the third fry basket.

The automated frying system places the third food product filled third fry basket into a third frying vat, after the food storage/dispensing unit has dispensed, through the dispensing shoot, the third food product to be fried in the fry system into the third fry basket, through the various processors, controllers, and motors of the basket transport system causing the vertically movable arm with the grasped third food product filled fry basket to move horizontally, along the horizontal track, from being parked in front of the food storage/dispensing unit to a location over the appropriate (third) fry vat of the frying system.

Upon locating the grasped third food product filled fry basket over the appropriate (third) fry vat of the frying system, the various processors, controllers, and motors of the basket transport system cause the vertically movable arm with the grasped third food product filled fry basket to move vertically so as to deposit the third fry basket into the appropriate (third) fry vat of the frying system. Once the grasped third food product filled fry basket is located in the appropriate (third) fry vat of the frying system 20, the end effector releases the third fry basket.

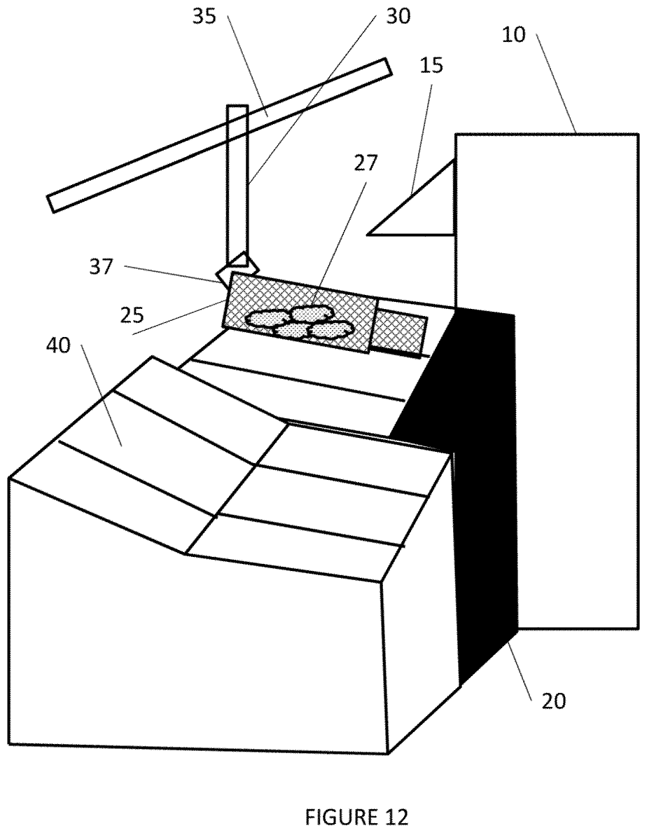

FIG. 12 illustrates the automated frying system lifting the first fry basket filled with fried first food product. As illustrated in FIG. 12, the various processors, controllers, and motors of the basket transport system cause the vertically movable arm 30 to move vertically towards the first fry basket 25 located in the first fry vat of the frying system 20. The movement of the vertically movable arm 30 may be a telescopic movement of the vertically movable arm 30. Upon engaging the first fry basket 25 located in the first fry vat of the frying system 20, the end effector 37 grasps or clamps the first fry basket 25.

As illustrated in FIG. 12, upon the end effector 37 grasping or clamping the first fry basket 25, the vertically movable arm 30 moves, by various processors, controllers, and motors of the basket transport system, vertically away from the first fry vat of the frying system 20, thereby lifting the first fry basket 25 out of the first fry vat of the frying system 20. The basket transport system may allow the first fry basket 25 to remain in that parked position for a predetermined amount of time to allow any excess frying oil to drip from the first fry basket 25 back into the first fry vat of the frying system 20.

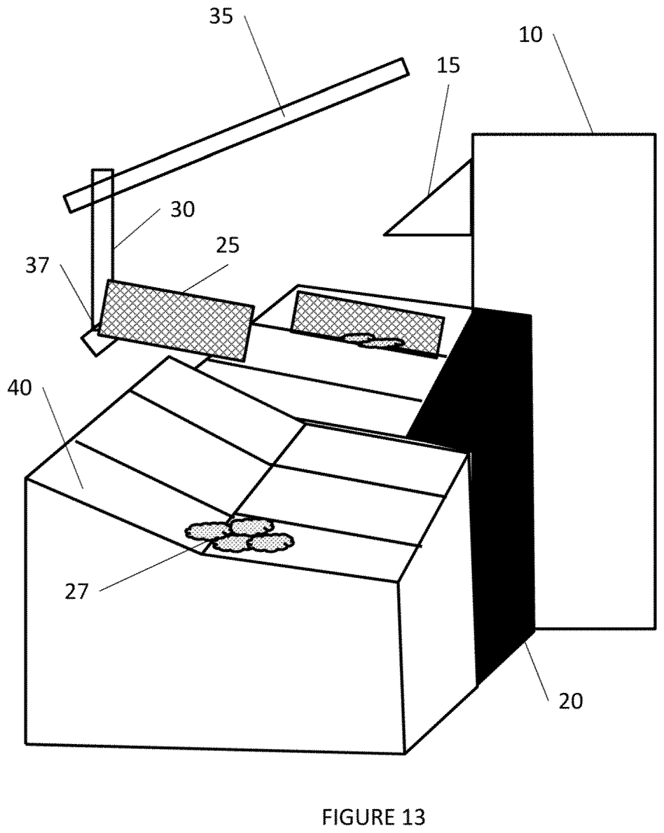

FIG. 13 illustrates the automated frying system emptying the first fry basket of the fried first food product into a first receiving bin. As illustrated in FIG. 13, the various processors, controllers, and motors of the basket transport system cause the vertically movable arm 30 with the grasped first fry basket 25 to move horizontally, along the horizontal track 35, from being parked over the first fry vat of the frying system 20 to a position over an appropriate dispensing bin of the prep station 40.

Once the grasped first fry basket 25 is parked over an appropriate dispensing bin of the prep station 40, the end effector 37 causes the grasped first fry basket 25 to rotate so as to deposit the fried food 27 into the appropriate dispensing bin of the prep station 40.

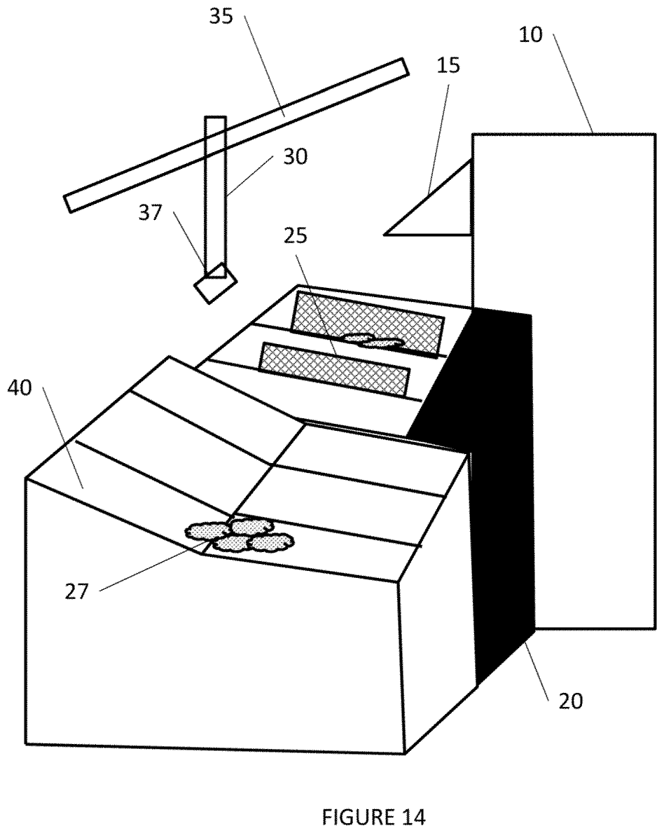

FIG. 14 illustrates the automated frying system after placing the emptied first fry basket into the first frying vat. As illustrated in FIG. 14, upon depositing the fried food 27 into the appropriate dispensing bin of the prep station 40, the various processors, controllers, and motors of the basket transport system cause the vertically movable arm 30 with the grasped empty first fry basket 25 to move horizontally, along the horizontal track 35, from being positioned over an appropriate dispensing bin of the prep station 40 to placing the empty first fry basket 25 into the first vat of the frying system 20.

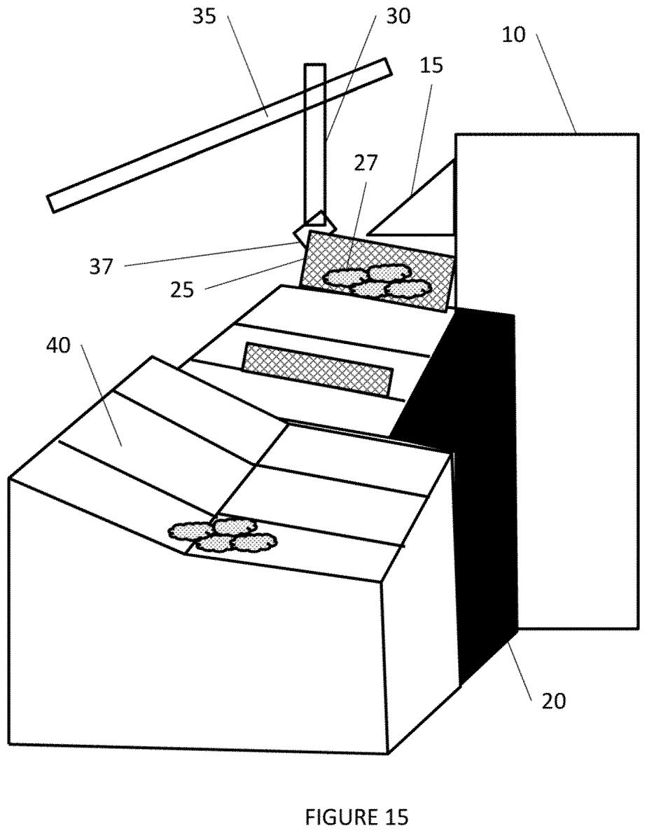

FIG. 15 illustrates the automated frying system lifting the second fry basket filled with fried second food product. The various processors, controllers, and motors of the basket transport system cause the vertically movable arm 30 to move horizontally, along the horizontal track 35, from being positioned over the first vat to being positioned over the second vat so that the second fry basket 25 can be grasped and lifted out of the second vat.

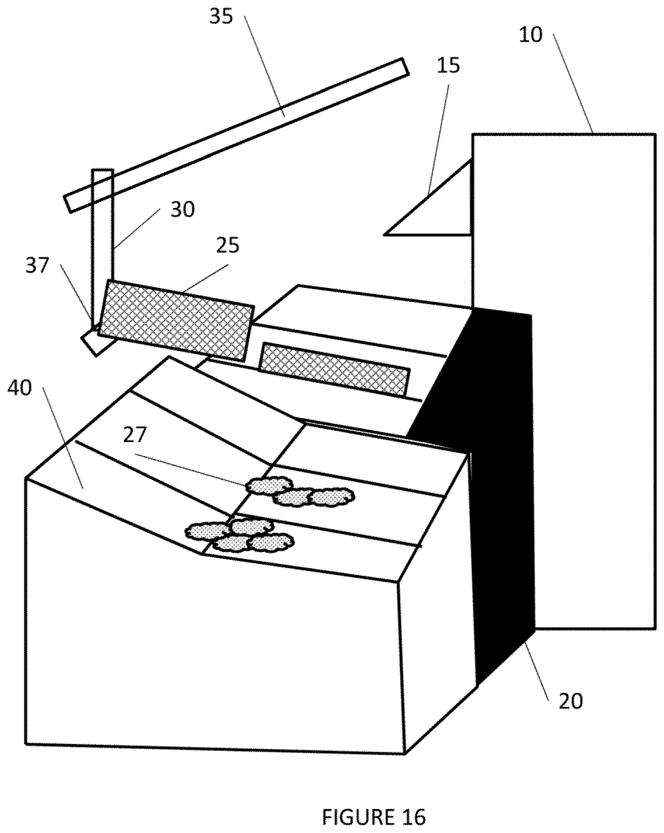

FIG. 16 illustrates the automated frying system emptying the second fry basket of the fried second food product into a second receiving bin. The various processors, controllers, and motors of the basket transport system cause the vertically movable arm 30 to move horizontally, along the horizontal track 35, from being positioned over the second vat to being positioned over an appropriate dispensing bin of the prep station 40 so that the contents of the second fry basket 25 can be deposited in the appropriate dispensing bin of the prep station 40.

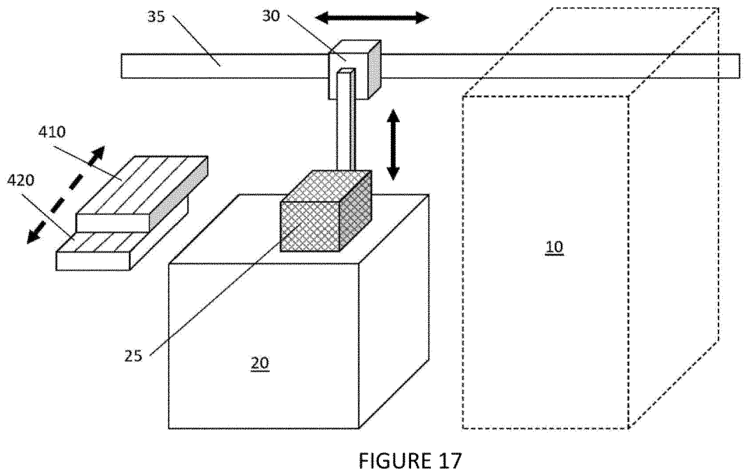

FIG. 17 illustrates an example of another embodiment of an automated frying system. As illustrated in FIG. 17, the automated frying system includes a food storage/dispensing unit 10 for storing food to be fried in the frying system. The food stored in the food storage/dispensing unit 10 is dispensed from a dispensing shoot 15. The food storage/dispensing unit 10 may a system to keep internal temperatures below freezing if the food to be fried is frozen food, or the food storage/dispensing unit 10 may a system to keep internal temperatures just above freezing if the food to be fried is not frozen, but needs to be kept cold or cool.

The automated frying system further includes a fry system 20 and a plurality of fry baskets 25. The fry system 20 includes multiple individual and independent fry vat to allow the frying of different foods with cross contamination and to fry foods at different temperatures. The fry system 20 may include a controller or controllers to maintain the proper frying temperatures.

The automated frying system includes a basket transport system having a horizontal track 35 and a vertically movable arm 30 that includes an end effector at the end of the vertically movable arm 30 that engages the fry basket 25. The basket transport system may include a controller, a processor, processors, controllers, and/or motors to facilitate movement of the various fry baskets 25 between the various stations or systems.

In addition, the automated frying system includes a prep station, which includes slideable trays (410 and 420) of bins where the fried food is deposited and held until it is properly packaged for distributing to the customer. The slideable trays (410 and 420) can slide back and forth horizontally to enable the depositing of multiple unique fried foods in distinct bins to avoid cross contamination. The sliding (movement) of the trays can be controlled, by a controller, a processor, processors, controllers, and/or motors, in conjunction with the food being transported to the prep station.

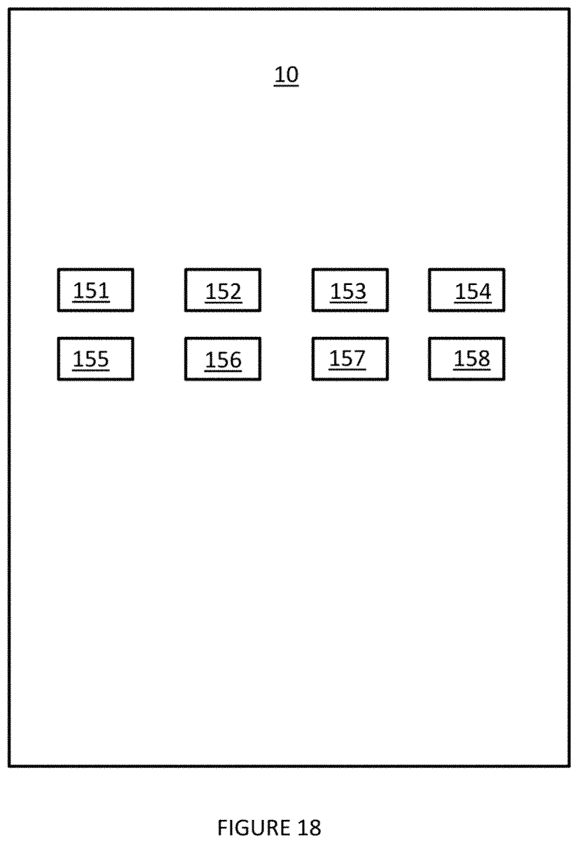

FIG. 18 illustrates an example of a delaminating food dispensing system for an automated frying system. As illustrated in FIG. 18, a food storage/dispensing unit 10 includes multiple dispensing shoots (151-158). Each dispensing shoot may dispense a distinct food product. The fry basket is positioned under the appropriate dispensing shoot to receive the food product to be fried.

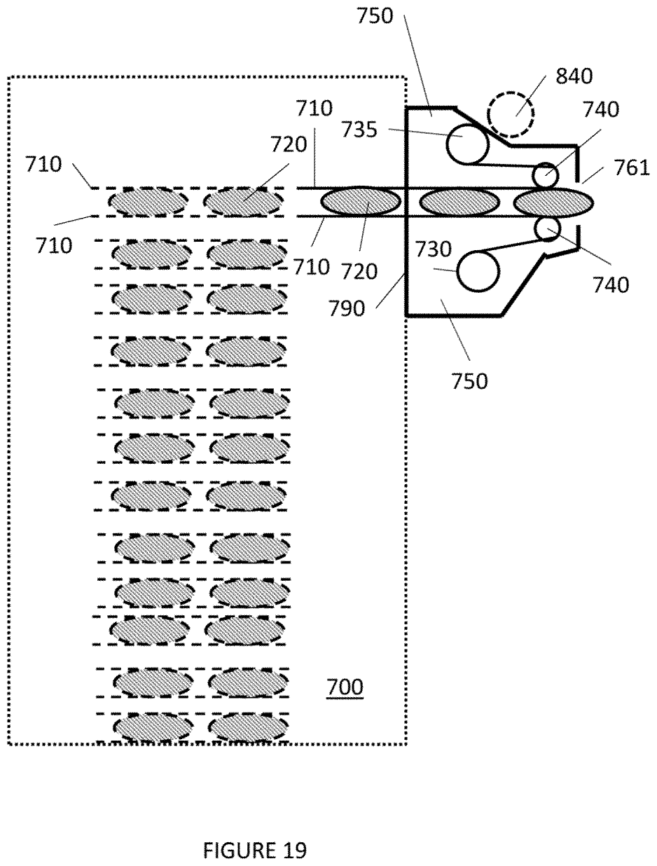

FIG. 19 illustrates a food dispensing module 700 for a delaminating food dispensing system, as described above. As illustrated in FIG. 19, the food dispensing module 700 houses food product 720, the food product 720 having been pre-laminated by two films 710.

As the food product 720 is dispensed from the food dispensing module 700, the food product 720 is delaminated from the two films 710 by delaminating nips 740. The delaminated food product 725 exits the food dispensing module 700.

The delaminating process is driven by a first film take-up roller 735 and a second take-up roller 730. Each take-up roller includes a drive gear (not shown), which mechanically rotates the take-up rollers.

Each take-up roller, upon rotation, rolls one of the films upon itself, driving the laminated food product 720 from its storage location to a location for being dispensed from the food dispensing module 700.

As illustrated in FIG. 19, the first film take-up roller 735 is operatively engaged to a drive mechanism 840 so that the drive mechanism 840 can control the rotation of the first film take-up roller 735 via its associated drive gear. In the embodiment of FIG. 19, the drive gear of the first film take-up roller 735 is mechanically linked to the drive gear of the second take-up roller 730 such that when the drive gear of the first film take-up roller 735 rotates the drive gear of the second take-up roller 730 rotates.

To facilitate the operative engagement of the first film take-up roller 735 with the drive mechanism 840, a portion of the drive gear of the first film take-up roller 735 is located outside the housing of the food dispensing module 700, thereby exposing a portion of the drive gear to the drive mechanism 840.

Alternatively, the second take-up roller 730 may be operatively engaged to the drive mechanism 840 so that the drive mechanism 840 can control the rotation of the second film take-up roller 730 via its associated drive gear. To facilitate the operative engagement of the second film take-up roller 730 with the drive mechanism 840, a portion of the drive gear of the second film take-up roller 730 would be located outside the housing of the food dispensing module 700, thereby exposing a portion of the drive gear to the drive mechanism 840.

As illustrated in FIG. 19, each take-up roller includes an associated trap void 750 which collects residual food product, such as blood, etc. Having a trap void 750 associated with each take-up roller allows flexibility in the orientation of the food dispensing module 700 within the delaminating food dispensing system.

The first take-up roller may include a drive gear, which mechanically rotates the first take-up rollers. The second take-up roller may include a drive gear, which mechanically rotates the second take-up rollers.

Each take-up roller, upon rotation, rolls one of the films upon itself, driving the laminated food product from its storage location to a location for being dispensed from the food dispensing module from an opening.

The drive gear is operatively engaged to a drive mechanism so that the drive mechanism can control the rotation of the first film take-up roller via its associated drive gear.

The drive gear of the first film take-up roller is mechanically linked to the drive gear of the second take-up roller such that when the drive gear of the first film take-up roller rotates the drive gear of the second take-up roller rotates.

To facilitate the operative engagement of the drive gear with the drive mechanism (not shown), a portion of the drive gear of the first film take-up roller is located outside the housing of the food dispensing module, thereby exposing a portion of the drive gear to the drive mechanism.

Alternatively, the second take-up roller may be operatively engaged to the drive mechanism so that the drive mechanism can control the rotation of the second film take-up roller via its associated drive gear.

To facilitate the operative engagement of the second film take-up roller with the drive mechanism, a portion of the drive gear of the second film take-up roller would be located outside the housing of the food dispensing module, thereby exposing a portion of the drive gear to the drive mechanism.

Each take-up roller includes an associated trap void which collects residual food product, such as blood, etc. Having a trap void associated with each take-up roller allows flexibility in the orientation of the food dispensing module within the delaminating food dispensing system.

Alternatively, the food dispensing module 700 may only include a single trap void which collects residual food product

Alternatively, the food dispensing module may only include a single trap void which collects residual food product.

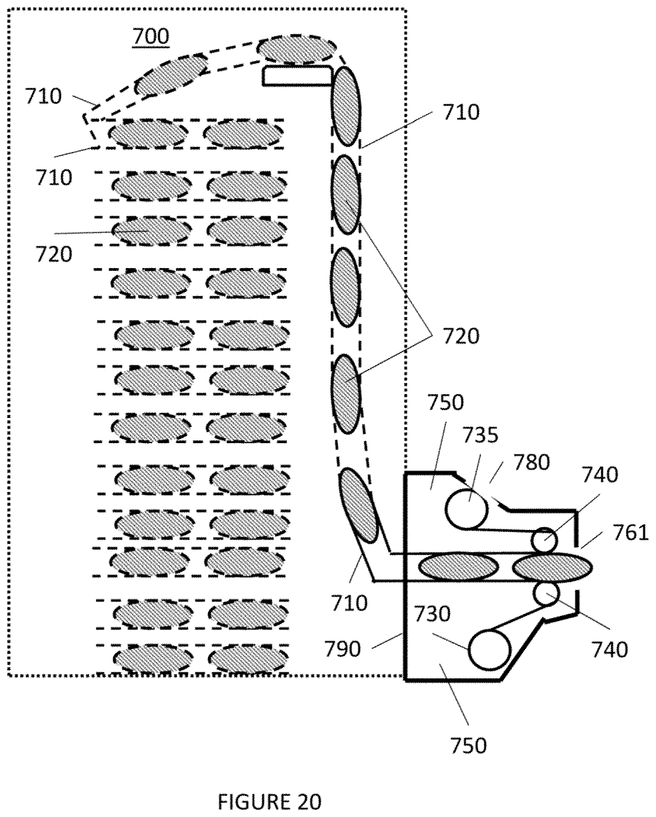

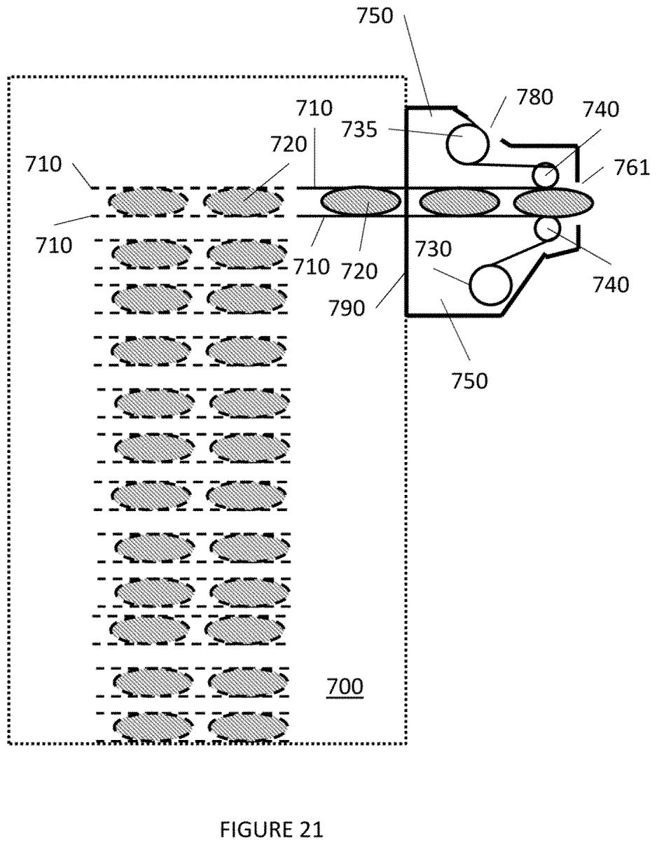

FIGS. 20 and 21 illustrate dispensing food dispensing modules for a delaminating food dispensing system.

As illustrated in FIG. 20, the drive mechanism 780 for the bottom food dispensing module is located above the associated delaminating unit 760.

As illustrated in FIG. 21, the drive mechanism 780 for the top food dispensing module is located above the associated delaminating unit 760.

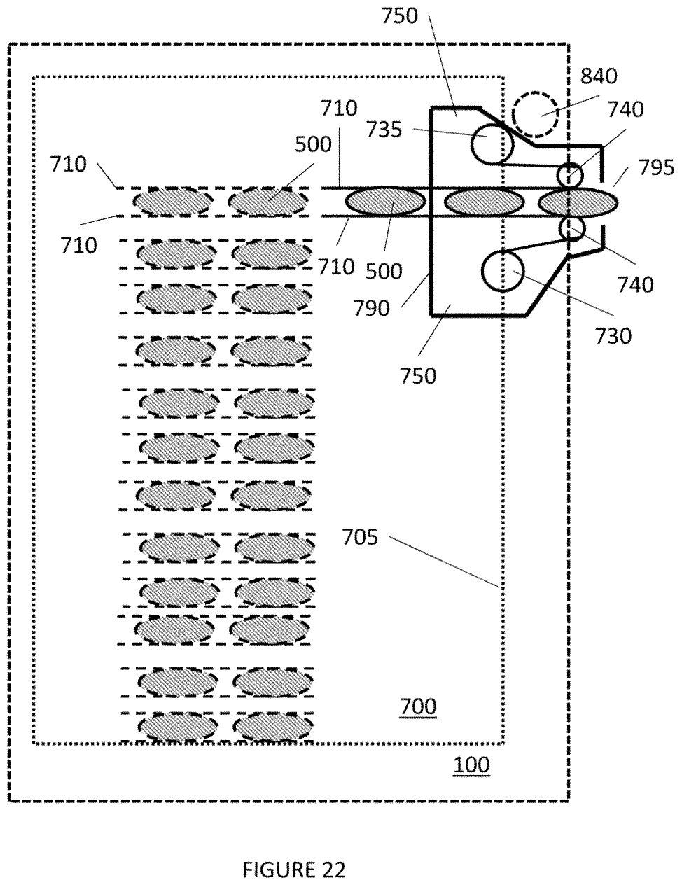

FIG. 22 illustrates a food dispensing module within a delaminating food dispensing system. As illustrated in FIG. 22, a food dispensing module 700 for a delaminating food dispensing system 100 includes an outer housing 705 and a delaminating housing 790. The delaminating housing 790 has a first portion which is located within the outer housing 705 and a second portion located outside the outer housing 705.

The delaminating housing 790 includes delaminating nips 740 for delaminating the food product 500 from the films 710 prior to dispensing. To facilitate the delamination process, the delaminating housing 790 includes a first film take-up roller 735 and a second film take-up roller 730. The first film take-up roller 735 and second film take-up roller 730 take-up the film 710, thereby pulling the film by delaminating nips 740 to delaminate the food product 500 from the films 710 prior to dispensing the food product 500 through output opening 795.

As illustrated in FIG. 22, each take-up roller includes an associated trap void 750 which collects residual food product. Having a trap void 750 associated with each take-up roller allows flexibility in the orientation of the food dispensing module 700 within the delaminating food dispensing system.

Moreover, as illustrated in FIG. 22, the output opening 795 is located in the second portion of the delaminating housing 790.

The first film take-up roller 735 includes a first drive gear (not shown) and the second film take-up roller 730 includes a second drive gear (not shown).

It is noted that the first drive gear may be mechanically linked to the second drive gear such that when the first drive gear rotates the second drive gear rotates.

A portion of the first drive gear is located outside the delaminating housing 790 and outside the outer housing 705 to engage drive mechanism 840.

It is noted that a portion of the second drive gear may be located outside the delaminating housing 790 and outside the outer housing 705 to engage drive mechanism 840.

The delaminating housing 790 may be detachably attached to the outer housing 705.

The outer housing 705 may be constructed of bio-degradable material or disposable material.

It is noted that the delaminating food dispensing system 100 may include tracks, rails, grooves, etc. (not shown) that physically engage the food dispensing module 700 to guide the food dispensing module 700 into its proper location within the delaminating food dispensing system 100 so that the drive gears can operatively engage the drive mechanism 840.

It is further noted that the food dispensing module 700 may include tracks, rails, grooves, etc. (not shown) that physically engage the delaminating food dispensing system 100 to guide the food dispensing module 700 into its proper location within the delaminating food dispensing system 100 so that the drive gears can operatively engage the drive mechanism 840.

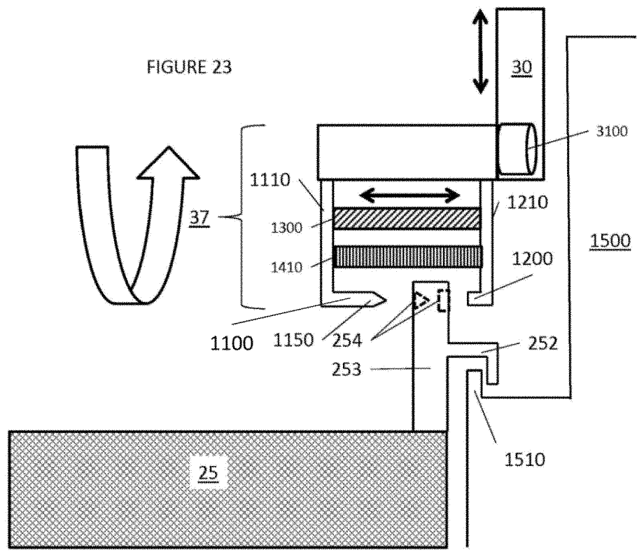

FIG. 23 illustrates the end effector 37 of the basket transport system of the automatic fryer system. The end effector 37 of the basket transport system is located at a first end of the vertically movable arm 30, the first end of the vertically movable arm 30 being at the end of the vertically movable arm 30 that engages the fryer basket 25. A second end of the vertically movable arm 30 being at the end of the vertically movable arm 30 that engages the horizontal track 35.

As illustrated in FIG. 23, the end effector 37 of the basket transport system includes a first clamp 1100 and a second clamp 1200. First clamp 1100 and second clamp 1200 grasp the fryer basket 25, wherein second clamp 1200 engages a backside of vertical member 253 of the fryer basket 25, the backside of vertical member 253 of the fryer basket 25 being a surface of the fryer basket 25 that is adjacent to a fryer system's back wall 1500, and first clamp 1100 engages a front side of vertical member 253 of the fryer basket 25, the front side of vertical member 253 of the fryer basket 25 being a surface of the fryer basket 25 that is away from a fryer system's back wall 1500.

It is noted that the backside of vertical member 253 of the fryer basket 25 may include an indentation 254, which matches a shape of second clamp 1200, to improve the engagement between the vertical member 253 of the fryer basket 25 and second clamp 1200.

It is further noted that a front side of vertical member 253 of the fryer basket 25 may include an indentation 254, which matches a shape of first clamp 1100, to improve the engagement between the vertical member 253 of the fryer basket 25 and first clamp 1100.

In addition, as illustrated in FIG. 23, the end effector 37 of the basket transport system includes a spring 1300, located between first clamp 1100 and second clamp 1200, so that first clamp 1100 and second clamp 1200 are biased in an opened position, as illustrated by horizontal arrow in FIG. 23. It is noted that the spring 1300 can be replaced by a device that provides a biasing force to bias first clamp 1100 and second clamp 1200 in an opened position, as illustrated.

Moreover, the end effector 37 of the basket transport system includes a drive mechanism 1410 to bring first clamp 1100 and second clamp 1200 together so that first clamp 1100 and second clamp 1200 are in a closed position.

It is noted that the drive mechanism 1410 may include a motorized rotatable take-up reel and a wire so that second clamp 1200 is pulled towards first clamp 1100, thereby placing first clamp 1100 and second clamp 1200 in a closed position.

By moving second clamp 1200 towards first clamp 1100, as illustrated by horizontal arrow in FIG. 23, the movement of second clamp 1200 enables the basket transport system to pull the fryer basket 25 away from fryer system's back wall 1500 and off of the hook 1510 on the fryer system's back wall 1500, the hook 1510 holding the fryer basket 25 above the fry vat of the fryer system by engaging a hook 252 on the fryer basket 25.

More specifically, the movement of second clamp 1200 enables the basket transport system to pull the fryer basket 25 away from fryer system's back wall 1500 and off of the hook 1510 on the fryer system's back wall 1500 without moving the vertically movable arm 30 of the basket transport system in a horizontal direction that is orthogonal or perpendicular to the fryer system's back wall 1500, thereby minimizing the movement of the vertically movable arm 30 of the basket transport system to movement in a vertical direction, as illustrated by vertical arrow in FIG. 23, and a horizontal direction, along the horizontal track, parallel to the fryer system's back wall 1500.

In other words, the arm 1110 of the end effector 37 associated with first clamp 1100 is maintained in its position, while the arm 1210 of the end effector 37 associated with second clamp 1200 is moved towards the arm 1110 of the end effector 37 associated with first clamp 1100 to provide the grasping or clamping of the fryer basket 25.

To facilitate the depositing of the fryer basket 25 back onto the hook 1510 on the fryer system's back wall 1500, first clamp 1100 may be telescopic such that first clamp 1100 includes a biasing device that biases first clamp 1100 into an extended state. When second clamp 1200 is moved towards the arm 1110 of the end effector 37 associated with first clamp 1100, first clamp 1100 telescopically collapses; however the biasing device within first clamp 1100 maintains first clamp 1100 against a front side of the fryer basket 25, thereby maintaining the grasping or clamping function.

On the other hand, when second clamp 1200 is moved away from (due to the bias force created by spring 1300) the arm 1110 of the end effector 37 associated with first clamp 1100, first clamp 1100 telescopically expands (due to the bias force created by the biasing device within first clamp 1100.

The biasing device within first clamp 1100 pushes the fryer basket 25 towards the fryer system's back wall 1500 so that the hook 252 of the fryer basket 25 over the hook 1510 on the fryer system's back wall 1500, thereby enabling the hook 252 of the fryer basket 25 to engage the hook 1510 on the fryer system's back wall 1500 when first clamp 1100 and second clamp 1200 are biased to the opened position.

As illustrated in FIG. 23, the first clamp 1100 may include a distinct shaped engagement end member 1150, such as an apex shape as illustrated, to engage the front side of the vertical member 253 of the fryer basket 25. As noted above, the front side of vertical member 253 of the fryer basket 25 may include indentation 254, which matches the distinct shape of the engagement end member 1150 of first clamp 1100, to improve the engagement between the vertical member 253 of the fryer basket 25 and first clamp 1100.

As further illustrated in FIG. 23, the end effector 37 can be rotated 180°, in a clockwise or counter-clockwise direction, (as illustrated by circular arrow) by a motor 3100, located in the vertically movable arm 30, to place the attached fryer basket 25 into a first orientation for unloading the contents of the fryer basket 25 or into a second orientation for loading the contents into the fryer basket 25 or placing the fryer basket 25 into a fryer vat. The end effector 37 is rotated by motor 3100 independently of the movement of the vertically movable arm 30.

It is noted that when a fryer basket is in a non-operational state (non-operational state being when the fryer basket is not being transported to a loading station (delaminator), a fry station (fryer), or output station (bin) and/or when the fryer basket does not contain food product), the fryer basket may be placed in the fryer vat or may be hung on the hook on the fryer system's back wall. When hanging on the hook on the fryer system's back wall, the fryer basket is above the fryer vat and out of the hot oil used to fry the food products.

By hanging the fryer basket on the hook on the fryer system's back wall, any excess oil on the fryer basket can drip back into the fryer vat.

In addition, it is noted that the fryer basket can be, for a predetermined period of time, hung on the hook on the fryer system's back wall after the frying operation is completed, so that any excess oil on the fried food products and/or the fryer basket can drip back into the fryer vat, thereby reducing the amount of oil being deposited into the output station (bin).

Also, when the fryer basket is, for a predetermined period of time, hung on the hook on the fryer system's back wall after the frying operation is completed, the removal of excess oil enables a cleaner operation and reduces the amount of oil that may be transmitted outside the fry vat onto the floor or other surfaces associated with the auto fryer system.

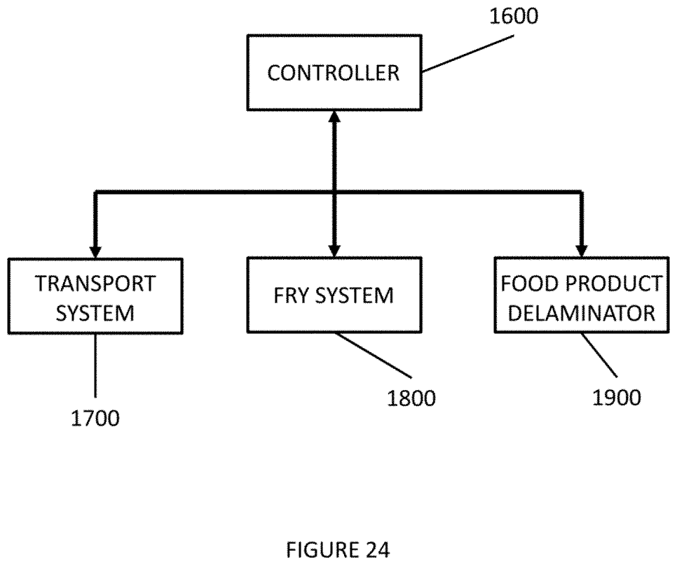

FIG. 24 illustrates a block diagram of the automated frying system. As illustrated in FIG. 24, the automated frying system includes a central control system (controller) 1600. The central control system (controller) 1600 may include (not shown) a processor or multiple processors, control circuitry, memory (read only memory, random access memory, disk memory, and/or solid state memory, buses, data input devices (interfaces—such as touchscreens, keyboards, and/or pointing devices), data output devices (interfaces—such as a display and/or LEDs), communication interface devices (wireless communication device, wired communication device, and/or Bluetooth™ communication device).

The central control system (controller) 1600 communicates (wireless, wired, and/or Bluetooth™) with the food product delaminator 1900 to control the dispensing of the appropriate food product into a fry basket, as described above and illustrated in FIG. 1 through FIG. 19.

The central control system (controller) 1600 communicates (wireless, wired, and/or Bluetooth™) with the basket transport system 1700 to control the movement of a fry basket between the food product delaminator 1900, the fry system 1800, and a prep station (not shown), as described above and illustrated in FIG. 1 through FIG. 19.

The central control system (controller) 1600 communicates (wireless, wired, and/or Bluetooth™) with the fry system 1800 to control the temperature of the cooking oils in the various fry vats of the fry system 1800.

It is noted that the functions (control) central control system (controller) 1600 may be realized by processors, application specific integrated circuits, firmware, software, and/or various combinations thereof.

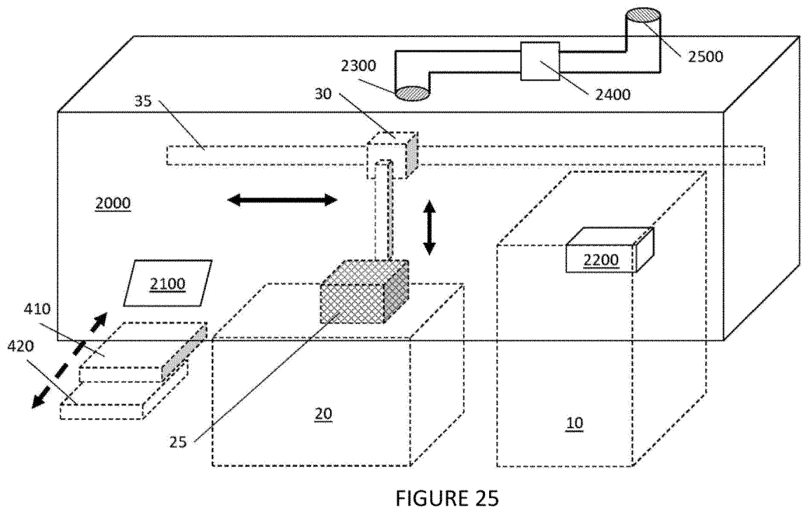

FIG. 25 illustrates an enclosure 2000 for an automated fry system for enclosing a frying system 20 and a fry basket transport system (30 and 35). The enclosure includes an opening or door 2200 for allowing the food from the food product delaminator 10 to be dispensed into a fry basket 25. Moreover, the enclosure includes an opening or door 2100 for allowing fried food from the fry basket 25 to be deposited into a prep station (410 and 420).

The enclosure 2000 includes an exhaust system having an intake vent opening 2300 for removing vapors, smoke, gases, etc. from or produced by the fry station 20. The intake vent opening 2300 is pneumatically connected to a fan/catalytic converter system 2400.

The fan/catalytic converter system 2400 draws the vapors, smoke, gases, etc. from the enclosed fry station 20 by producing a negative pressure on an intake side of the fan/catalytic converter system 2400. The fan/catalytic converter system 2400 also combusts the vapors, smoke, gases, etc. drawn from the enclosed fry station 20 to create an exhaust gas that can be properly expelled to the ambient environment without requiring venting of the vapors, smoke, gases, etc. drawn from the enclosed fry station 20 to the outside environment.

The fan/catalytic converter system 2400 is pneumatically connected to an outlet vent 2500 to expel the combusted (catalytic converted) gas to the ambient environment. In other words, the combusted (catalytic converted) gas can be expelled within the cooking area without requiring the venting to an outside environment.

The enclosure 2000 provides a gas containment system so that the vapors, smoke, gases, etc. produced by the fry station 20 can be properly contained and not allowed the vapors, smoke, gases, etc. produced by the fry station 20 to contaminant the ambient environment within the cooking/prep area outside of the enclosure 2000.

The enclosure 2000 provides a physical shield for the robotic operations of the automated fry system from an employee so that the employee is not accidently injured.

In addition, enclosure 2000 is substantially hermetically sealed so that the captured gases are expelled properly and not allowed to escape into the cooking/prep area.

As noted above, to enable interaction with the food product delaminator 10, which is located outside the enclosure 2000, the enclosure 2000 includes door or opening 2200. The dispensing shoot of the food product delaminator 10 is positioned so that the food being dispensed can travel through the door or opening 2200 and be deposited into a fry basket 25.

If the door or opening 2200 is an actual door, the door is only opened when the food product delaminator 10 is dispensing food to be deposited into a fry basket 25, so as to minimize the impact on the hermetically sealed state of the enclosure 2000.

If the air movement capacity of the fan/catalytic converter system 2400 is large enough to maintain a sustain negative pressure within the enclosure 2000, the door or opening 2200 can be an opening because the sustain negative pressure created the air movement capacity of the fan/catalytic converter system 2400 minimizes the impact on the hermetically sealed state of the enclosure 2000.

As noted above, to enable interaction with the prep station (410 and 420), which is located outside the enclosure 2000, the enclosure 2000 includes door or opening 2100. The door or opening 2100 is positioned so that the fried food can travel through the door or opening 2100 and be deposited into the prep station (410 and 420).

If the door or opening 2100 is an actual door, the door is only opened when the fried food is being deposited into the prep station (410 and 420), so as to minimize the impact on the hermetically sealed state of the enclosure 2000.

If the air movement capacity of the fan/catalytic converter system 2400 is large enough to maintain a sustain negative pressure within the enclosure 2000, the door or opening 2100 can be an opening because the sustain negative pressure created the air movement capacity of the fan/catalytic converter system 2400 minimizes the impact on the hermetically sealed state of the enclosure 2000.

The enclosure 2000 provides the necessary ventilation solution to allow the automated fry system to be placed in a small space which may not have the necessary access to an outside environment for ventilation.

In summary, a food dispensing module for a delaminating food dispensing system includes an outer housing; and a delaminating housing; the delaminating housing having a first portion being located within the outer housing and a second portion located outside the outer housing; the delaminating housing including delaminating nips, a first film take-up roller, a second film take-up roller, an output opening, and a trap void; the output opening being located in the second portion of the delaminating housing.

The first film take-up roller may include a first drive gear and the second film take-up roller includes a second drive gear.

The first drive gear may be mechanically linked to the second drive gear such that when the first drive gear rotates the second drive gear rotates.

A portion of the first drive gear may be located outside the delaminating housing and outside the outer housing.

The portion of the first drive gear may be located outside the delaminating housing and outside the outer housing operatively engages a driving mechanism.

The first drive gear may be mechanically linked to the second drive gear such that when the first drive gear rotates the second drive gear rotates.

A portion of the second drive gear may be located outside the delaminating housing and outside the outer housing.

The portion of the second drive gear may be located outside the delaminating housing and outside the outer housing operatively engages a driving mechanism.

A portion of the first drive gear may be located outside the delaminating housing and outside the outer housing and a portion of the second drive gear is located outside the delaminating housing and outside the outer housing.

The portion of the first drive gear may be located outside the delaminating housing and outside the outer housing operatively engages a driving mechanism and the portion of the second drive gear located outside the delaminating housing and outside the outer housing operatively engages the driving mechanism.

The portion of the first drive gear may be located outside the delaminating housing and outside the outer housing operatively engages a first driving mechanism and the portion of the second drive gear located outside the delaminating housing and outside the outer housing operatively engages a second driving mechanism.

The delaminating housing may be detachably attached to the outer housing.

The outer housing may include laminated food product.

The outer housing may be constructed of bio-degradable material.

The outer housing may be constructed of disposable material.

A delaminating food dispensing system includes a housing; a drive mechanism; a first food dispensing module; a second food dispensing module; a first food dispensing module opening; and a second food dispensing module opening; the first food dispensing module including a first food dispensing module outer housing, and a first food dispensing module delaminating housing; the first food dispensing module delaminating housing having a first portion being located within the first food dispensing module outer housing and a second portion located outside the first food dispensing module outer housing; the first food dispensing module delaminating housing including first food dispensing module delaminating nips, a first food dispensing module first film take-up roller, a first food dispensing module second film take-up roller, a first food dispensing module output opening, and a first food dispensing module trap void; the first food dispensing module output opening being located in the second portion of the first food dispensing module delaminating housing; the second food dispensing module including a second food dispensing module outer housing, and a second food dispensing module delaminating housing; the second food dispensing module delaminating housing having a first portion being located within the second food dispensing module outer housing and a second portion located outside the second food dispensing module outer housing; the second food dispensing module delaminating housing including second food dispensing module delaminating nips, a second food dispensing module first film take-up roller, a second food dispensing module second film take-up roller, a second food dispensing module output opening, and a second food dispensing module trap void; the second food dispensing module output opening being located in the second portion of the first food dispensing module delaminating housing.

The first food dispensing module may be located side-by-side with the second food dispensing module in the housing.

The first food dispensing module may be located above the second food dispensing module in the housing.

The first food dispensing module first film take-up roller may include a first drive gear; the first food dispensing module second film take-up roller including a second drive gear; the second food dispensing module first film take-up roller including a third drive gear; the second food dispensing module second film take-up roller including a fourth drive gear.

The first drive gear may be mechanically linked to the second drive gear such that when the first drive gear rotates the second drive gear rotates and the third drive gear is mechanically linked to the fourth drive gear such that when the third drive gear rotates the fourth drive gear rotates.

A portion of the first drive gear may be located outside the first food dispensing module delaminating housing and outside the first food dispensing module outer housing and a portion of the third drive gear is located outside the second food dispensing module delaminating housing and outside the second food dispensing module outer housing.

The portion of the first drive gear may be located outside the first food dispensing module delaminating housing and outside the first food dispensing module outer housing operatively engages the drive mechanism and the portion of the third drive gear located outside the second food dispensing module delaminating housing and outside the second food dispensing module outer housing operatively engages the drive mechanism.

A portion of the second drive gear may be located outside the first food dispensing module delaminating housing and outside the first food dispensing module outer housing and a portion of the fourth drive gear is located outside the second food dispensing module delaminating housing and outside the second food dispensing module outer housing.

The portion of the second drive gear may be located outside the first food dispensing module delaminating housing and outside the first food dispensing module outer housing operatively engages the drive mechanism and the portion of the fourth drive gear located outside the second food dispensing module delaminating housing and outside the second food dispensing module outer housing operatively engages the drive mechanism.

A portion of the first drive gear may be located outside the first food dispensing module delaminating housing and outside the first food dispensing module outer housing; a portion of the third drive gear may be located outside the second food dispensing module delaminating housing and outside the second food dispensing module outer housing; a portion of the second drive gear may be located outside the first food dispensing module delaminating housing and outside the first food dispensing module outer housing; and a portion of the fourth drive gear may be located outside the second food dispensing module delaminating housing and outside the second food dispensing module outer housing.

The portion of the first drive gear may be located outside the first food dispensing module delaminating housing and outside the first food dispensing module outer housing operatively engages the drive mechanism; the portion of the third drive gear located outside the second food dispensing module delaminating housing and outside the second food dispensing module outer housing operatively engaging the drive mechanism; the portion of the second drive gear located outside the first food dispensing module delaminating housing and outside the first food dispensing module outer housing operatively engaging the drive mechanism; and the portion of the fourth drive gear located outside the second food dispensing module delaminating housing and outside the second food dispensing module outer housing operatively engaging the drive mechanism.

The first food dispensing module delaminating housing may be detachably attached to the first food dispensing module outer housing and the second food dispensing module delaminating housing is detachably attached to the second food dispensing module outer housing.

The first food dispensing module outer housing may include laminated food product and the second food dispensing module outer housing may include laminated food product.

The first food dispensing module outer housing may be constructed of bio-degradable material and the second food dispensing module outer housing is constructed of bio-degradable material.

The first food dispensing module outer housing may be constructed of disposable material and the second food dispensing module outer housing is constructed of disposable material.

A food module for a food dispensing module used in a delaminating food dispensing system includes a first film having a first portion and a second portion; a second film having a first portion and a second portion; food product; a delaminating housing; a first delaminating nip; a second delaminating nip; a first film take-up roller; a second film take-up roller; an output opening; and a trap void; the food product being laminated between the first portion of the first film and the first portion of the second film; the second portion of the first film being detachably attached to the first film take-up roller; the second portion of the first film engaging the first delaminating nip; the second portion of the second film being detachably attached to the second film take-up roller; the second portion of the second film engaging the second delaminating nip.

The first film take-up roller may include a first drive gear and the second film take-up roller includes a second drive gear.

The first drive gear may be mechanically linked to the second drive gear such that when the first drive gear rotates the second drive gear rotates.

A portion of the first drive gear may be located outside the delaminating housing.

The portion of the first drive gear may be located outside the delaminating housing engages a driving mechanism.

The first drive gear may be mechanically linked to the second drive gear such that when the first drive gear rotates the second drive gear rotates.

A portion of the second drive gear may be located outside the delaminating housing.

The portion of the second drive gear may be located outside the delaminating housing engages a driving mechanism.

A portion of the first drive gear may be located outside the delaminating housing and a portion of the second drive gear is located outside the delaminating housing.

The portion of the first drive gear may be located outside the delaminating housing operatively engages a driving mechanism and the portion of the second drive gear located outside the delaminating housing operatively engages the driving mechanism.

The portion of the first drive gear may be located outside the delaminating housing operatively engages a first driving mechanism and the portion of the second drive gear located outside the delaminating housing operatively engages a second driving mechanism.

A delaminating food module includes a housing; a first delaminating nip; a second delaminating nip; a first film take-up roller; a second film take-up roller; an output opening; and a trap void.

The first film take-up roller may include a first drive gear and the second film take-up roller includes a second drive gear.

The first drive gear may be mechanically linked to the second drive gear such that when the first drive gear rotates the second drive gear rotates.

A portion of the first drive gear may be located outside the housing.

The portion of the first drive gear may be located outside the housing enables engagement of a driving mechanism.

The first drive gear may be mechanically linked to the second drive gear such that when the first drive gear rotates the second drive gear rotates.

A portion of the second drive gear may be located outside the housing.

The portion of the second drive gear may be located outside the housing enables engagement of a driving mechanism.

A portion of the first drive gear may be located outside the housing and a portion of the second drive gear is located outside the housing.

The portion of the first drive gear may be located outside the housing enables engagement of a driving mechanism and the portion of the second drive gear located outside the housing enables engagement of the driving mechanism.

The portion of the first drive gear may be located outside the housing enables engagement of a first driving mechanism and the portion of the second drive gear located outside the housing enables engagement of a second driving mechanism.

A delaminating food dispensing system includes a housing; a drive mechanism; a food dispensing module; and a food dispensing module opening; and the food dispensing module including an outer housing, and a delaminating housing; the delaminating housing having a first portion being located within the outer housing and a second portion located outside the outer housing; the food dispensing module delaminating housing including, delaminating nips, a first film take-up roller, a second film take-up roller, an output opening, and a trap void; the output opening being located in the second portion of the delaminating housing.

The first film take-up roller may include a first drive gear and the second film take-up roller includes a second drive gear.

The first drive gear may be mechanically linked to the second drive gear such that when the first drive gear rotates the second drive gear rotates.

A portion of the first drive gear may be located outside the housing.

The portion of the first drive gear may be located outside the housing enables engagement of a driving mechanism.

The first drive gear may be mechanically linked to the second drive gear such that when the first drive gear rotates the second drive gear rotates.

A portion of the second drive gear may be located outside the housing.

The portion of the second drive gear may be located outside the housing enables engagement of a driving mechanism.

A portion of the first drive gear may be located outside the housing and a portion of the second drive gear is located outside the housing.

The portion of the first drive gear may be located outside the housing enables engagement of a driving mechanism and the portion of the second drive gear located outside the housing enables engagement of the driving mechanism.

The portion of the first drive gear may be located outside the housing enables engagement of a first driving mechanism and the portion of the second drive gear located outside the housing enables engagement of a second driving mechanism.

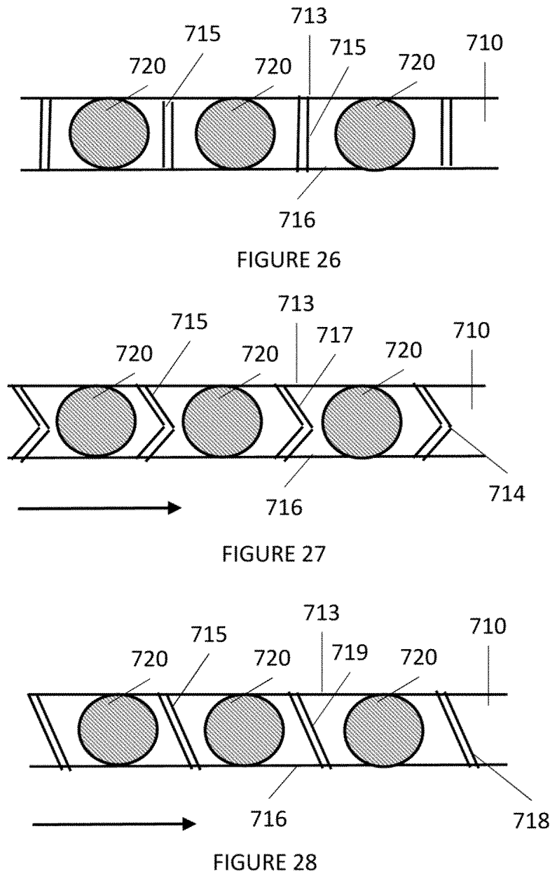

FIG. 26 illustrates a conventional seal for a laminated food product. As illustrated in FIG. 26, the laminated food product includes a food product 720 laminated by a laminate 710 consisting of two laminating layers (not specifically illustrated). Each laminating layer includes a first edge 713 and a second edge 716. The first edge 713 and the second edge 716 are parallel thereto. Between each food product 720, a seal 715 is formed between the two laminating layers.

As illustrated in FIG. 26, the seal 715 is orthogonally formed between the first edges 713 and the second edges 716 of the two laminating layers. Such an orthogonal seal can cause issues when delaminating the food product 720 from the laminate 710 because the entire seal 715 is broken at once.

FIG. 27 illustrates a seal for a lamented food product that enables the seal to be gradually broken during delamination. As illustrated in FIG. 27, the laminated food product includes a food product 720 laminated by a laminate 710 consisting of two laminating layers (not specifically illustrated). Each laminating layer includes a first edge 713 and a second edge 716. Between each food product 720, a seal 717 is formed between the two laminating layers.

More specifically, as illustrated in FIG. 27, seal 717 is non-orthogonally formed between the first edges 713 and the second edges 716 of the two laminating layers to form an apex shape or an arrow tip shape. In other words, seal 717 forms, in the direction of the arrow, a non-orthogonal angle with first edge 713, and seal 717 forms, in the direction of the arrow, a congruent non-orthogonal angle with second edge 716.

Having such non-orthogonal angle interfaces with the first edges 713 and the second edges 716, the seal 717 converges at the center (center line) of the laminate 710 to form the apex shape or the arrow tip shape.

Such a non-orthogonal seal reduces or eliminates the issues associated with delaminating the food product 720 from the laminate 710 because the entire seal 717 is not broken at once, but broken gradually, as the delamination process progresses.

In other words, as illustrated in FIG. 27, the leading edge 714 of the apex shaped or arrow tip shaped seal 717 is broken first during the delamination process. The seal 717 continues to be broken in a direction away from the leading edge 714, as the delamination process progresses.

FIG. 28 illustrates another seal for a lamented food product that enables the seal to be gradually broken during delamination. As illustrated in FIG. 28, the laminated food product includes a food product 720 laminated by a laminate 710 consisting of two laminating layers (not specifically illustrated). Each laminating layer includes a first edge 713 and a second edge 716. Between each food product 720, a seal 719 is formed between the two laminating layers.

More specifically, as illustrated in FIG. 28, seal 719 is non-orthogonally formed between the first edges 713 and the second edges 716 of the two laminating layers to form a slash shape. In other words, seal 719 forms, in the direction of the arrow, a non-orthogonal angle with first edge 713, and seal 719 forms, in the direction of the arrow, a supplemental non-orthogonal angle with second edge 716.

Having such non-orthogonal angle interfaces with the first edges 713 and the second edges 716, the seal 719 forms the slash shape.

Such a non-orthogonal seal reduces or eliminates the issues associated with delaminating the food product 720 from the laminate 710 because the entire seal 719 is not broken at once, but broken gradually as the delamination process progresses.

In other words, as illustrated in FIG. 28, the leading edge 718, at second edge 716, of the slash shaped seal 719 is broken first during the delamination process. The seal 719 continues to be broken in a direction away from the leading edge 718 and towards the first edge 713, as the delamination process progresses.

It is noted that FIGS. 27 and 28 merely show examples of the seals' orientation with respect to edges of the laminate. Any non-orthogonal orientation, with respect to edges of the laminate, provides a seal that is not entirely broken at once, but broken gradually as the delamination process progresses.

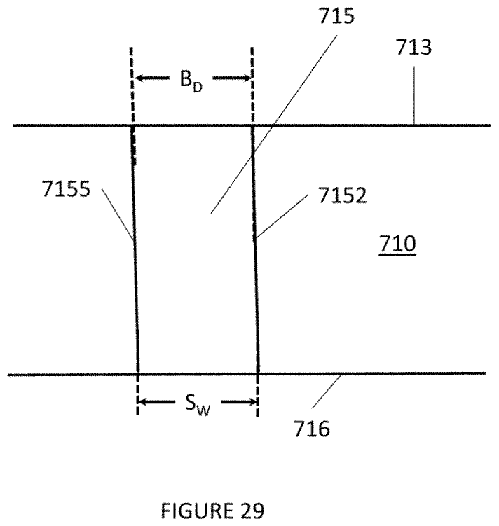

FIG. 29 illustrates the dimensional relationship of the conventional seal 715 of FIG. 26. As illustrated in FIG. 29, a laminate 710 consisting of two laminating layers has a seal 715 located between food products (not shown). The conventional seal 715 of FIG. 29 is formed at an orthogonal angle to the first edges 713 and the second edges 716 of the laminating layers.

The seal 715, as illustrated, has a width S_{W}. FIG. 29 also illustrates that a laminate 710 travels a distance B_{D} before the entire seal 715 is broken during a delamination process. In the conventional configuration, the width S_{W} of the seal 715 is equal to the distance B_{D} that the laminate 710 travels before the entire seal 715 is broken during a delamination process.

The distance B_{D} is also defined as the distance between a leading edge 7152 of the seal 715 and a trailing edge 7155 of the seal 715. Thus, as illustrated in FIG. 29, the distance B_{D} between the leading edge 7152 of the seal 715 and the trailing edge 7155 of the seal 715 is equal to the width S_{W} of the seal 715. When the distance B_{D} between the leading edge 7152 of the seal 715 and the trailing edge 7155 of the seal 715 is equal to the width S_{W} of the seal 715, the delamination process may encounter issues when breaking the seal 715.

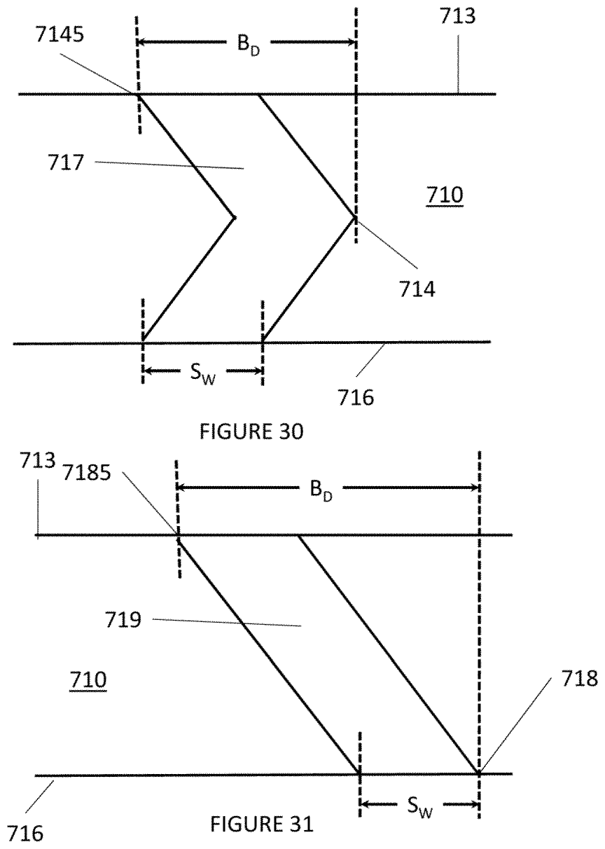

FIG. 30 illustrates the dimensional relationship of the seal 717 of FIG. 27. As illustrated in FIG. 30, a laminate 710 consisting of two laminating layers has a seal 717 located between food products (not shown). The seal 717 of FIG. 30 is formed at a non-orthogonal angle to the first edges 713 and the second edges 716 of the laminating layers.

The seal 717, as illustrated, has a width S_{W}. FIG. 30 also illustrates that a laminate 710 travels a distance B_{D} before the entire seal 717 is broken during a delamination process. In this configuration, the width S_{W} of the seal 717 is not equal to the distance B_{D} that the laminate 710 travels before the entire seal 717 is broken during a delamination process.

The distance B_{D} is also defined as the distance between a leading edge 714 of the seal 717 and a trailing edge 7145 of the seal 717. Thus, as illustrated in FIG. 30, the distance B_{D} between the leading edge 714 of the seal 717 and the trailing edge 7145 of the seal 717 is not equal to the width S_{W} of the seal 717.

When the distance B_{D} between the leading edge 714 of the seal 717 and the trailing edge 7145 of the seal 717 is not equal to the width S_{W} of the seal 717, the delamination process eliminates or reduces issues when breaking the seal 717 because the seal 717 is broken gradually as the delamination process progresses.

FIG. 31 illustrates the dimensional relationship of the seal 719 of FIG. 28. As illustrated in FIG. 31, a laminate 710 consisting of two laminating layers has a seal 719 located between food products (not shown). The seal 719 of FIG. 31 is formed at a non-orthogonal angle to the first edges 713 and the second edges 716 of the laminating layers.

The seal 719, as illustrated, has a width S_{W}. FIG. 31 also illustrates that a laminate 710 travels a distance B_{D} before the entire seal 719 is broken during a delamination process. In this configuration, the width S_{W} of the seal 719 is not equal to the distance B_{D} that the laminate 710 travels before the entire seal 719 is broken during a delamination process.

The distance B_{D} is also defined as the distance between a leading edge 718 of the seal 719 and a trailing edge 7185 of the seal 719. Thus, as illustrated in FIG. 31, the distance B_{D} between the leading edge 718 of the seal 719 and the trailing edge 7185 of the seal 719 is not equal to the width S_{W} of the seal 719.

When the distance B_{D} between the leading edge 718 of the seal 719 and the trailing edge 7185 of the seal 719 is not equal to the width S_{W} of the seal 719, the delamination process eliminates or reduces issues when breaking the seal 719 because the seal 719 is broken gradually as the delamination process progresses.

As illustrated in FIGS. 27, 28, 30, and 31, configuring the seal to interface with the edges of the laminate so that the distance between the leading edge of the seal and the trailing edge of the seal is not equal to the width of the seal, the delamination process eliminates or reduces issues when breaking the seal because the seal is broken gradually as the delamination process progresses.

It is noted that although the above embodiments discussed specific shapes of the seal and/or specific angles of the interface between the seal and the edges of the laminate, other shapes and/or angles may be utilized as long as the distance between the leading edge of the seal and the trailing edge of the seal is not equal to the width of the seal.

It is further noted that although the above embodiments discussed specific shapes of the seal and/or specific angles of the interface between the seal and the edges of the laminate, other shapes and/or angles may be utilized as long as the width of the seal is not equal to the distance that the laminate travels before the entire seal 719 is broken during a delamination process.

It is additionally noted that although the above embodiments discuss the frying of a food products, the system can easily be implemented in a steam system for steaming food products.

An automatic fryer system includes a fry basket; a fryer unit having a fry vat for housing heated cooking oil and receiving the fry basket; the fryer unit including a rear wall having a fry basket hooking member located thereon for parking the fry basket; a horizontal drive system for moving the fry basket in a horizontal direction; a vertical drive system, operatively connected to the horizontal drive system, for moving the fry basket in a vertical direction; an end effector for grasping and holding the fry basket; a food product loading unit for loading food product into the fry basket; and a controller, in operational communication with the horizontal drive system; the vertical drive system, and the end effector, to control a location and an orientation of the fry basket.

The controller may control the horizontal drive system to move the fry basket from a first location associated with the fryer unit to a second location associated with the food product loading unit and to move the fry basket from the second location associated with the food product loading unit to the first location associated with the fryer unit.

The automatic fryer system may include a fried product staging unit.

The fryer basket may have a closed end and an open end; the controller, when the fry basket is located at the third location associated with the fried product staging unit, controlling the end effector to rotate the fry basket such that the open end of the fry basket is orientated, with respect to the fried product staging unit, to facilitate unloading of food product from the fry basket into the fried product staging unit.

The controller controls the vertical drive system to move the fry basket from a third location above the fry vat of the fryer unit to a fourth location within the fry vat of the fryer unit and to move the fry basket from the fourth location within the fry vat of the fryer unit to the third location above the fry vat of the fryer unit.

The automatic fryer system as claimed in claim 3, wherein the controller controls the horizontal drive system to move the fry basket from associated with the fryer unit to a third location associated with the fried product staging unit.

The end effector may include a first clamp; a second clamp; a biasing device to bias the first clamp and the second clamp in an opened position; a drive mechanism to move the first clamp and the second clamp together; and a rotation mechanism to rotate the first clamp and the second clamp.

The first clamp may include a first shaped engagement end member and the second clamp may include a second shaped engagement end member.

The first shaped engagement end member may have a shape to match a first indentation in the fry basket and the second shaped engagement end member may have a shape to match a second indentation in the fry basket.

The biasing device may be a spring.

The drive mechanism may be a motorized take-up reel on the first clamp and a wire connected to the second clamp and the motorized take-up reel.

The automatic fryer system may include an enclosure; the enclosure including, an intake vent opening for removing vapors, smoke, gases, produced by the fryer unit station, a fan/catalytic converter system, pneumatically connected to the intake vent opening, to combust the vapors, smoke, gases drawn from the fryer unit station to create an exhaust gas that can be properly expelled to the ambient environment, and an outlet vent, pneumatically connected to the fan/catalytic converter system, to expel the combusted gas to the ambient environment.

The food product loading unit may be a delaminating food dispensing system including an outer housing; and a delaminating housing; the delaminating housing having a first portion being located within the outer housing and a second portion located outside the outer housing; the delaminating housing including, delaminating nips, a first film take-up roller, a second film take-up roller, an output opening, and a trap void; the output opening being located in the second portion of the delaminating housing.

An end effector for grasping a fry basket includes a first clamp; a second clamp; a biasing device to bias the first clamp and the second clamp in an opened position; a drive mechanism to move the first clamp and the second clamp together; and a rotation mechanism to rotate the first clamp and the second clamp.

The first clamp may include a first shaped engagement end member and the second clamp may include a second shaped engagement end member.

The first shaped engagement end member may have a shape to match a first indentation in the fry basket and the second shaped engagement end member may have a shape to match a second indentation in the fry basket.

The first shaped engagement end member may have a shape to match a first projection on the fry basket and the second shaped engagement end member may have a shape to match a second projection on the fry basket.

The biasing device may be a spring.

The drive mechanism may be a motorized take-up reel on the first clamp and a wire connected to the second clamp and the motorized take-up reel.

A laminated food product includes a first lamination film having a first side and a second side; a second lamination film having a first side and a second side; a plurality of food products positioned between the first lamination film and the second lamination film; and a seal, located between adjacent food products, to seal the first lamination film to the second lamination film; the seal and the first side of the first lamination film forming a first non-orthogonal angle; the seal and the second side of the first lamination film forming a second non-orthogonal angle.

The first non-orthogonal angle may be supplemental to the second non-orthogonal angle.

The seal may include a first seal portion and a second seal portion; the first seal portion and the first side of the first lamination film forming a first non-orthogonal angle; the second seal portion and the second side of the first lamination film forming a second non-orthogonal angle; the first seal portion and the second seal portion meeting a point between the first side of the first lamination film and the second side of the first lamination film to form an apex.

A method for automatically frying food products, includes (a) grasping, with an end effector connected to a vertical drive unit, a fry basket hooked on a fry unit above a fry vat; (b) moving horizontally, using a horizontal drive unit, the grasped fry basket to a location corresponding to a food product loading unit; (c) loading, using a delaminating food dispensing system, the fry basket with food product; (d) moving horizontally, using the horizontal drive unit, the food product loaded fry basket to a location above the fry vat; (e) moving vertically, using the vertical drive unit, the food product loaded fry basket into the fry vat; (f) cooking, in the fry vat, the food product; (g) moving vertically, using the vertical drive unit, the cooked food product loaded fry basket out of the fry vat; (h) moving horizontally, using the horizontal drive unit, the cooked food product loaded fry basket to a location corresponding to a cooked food product staging unit; (i) rotating in a first direction, using the end effector, the cooked food product loaded fry basket to unload the cooked food product into the cooked food product staging unit; (j) moving horizontally, using the horizontal drive unit, the empty fry basket to the location above the fry vat; and (k) hooking, using an end effector and the vertical drive unit, the fry basket on the fry unit above the fry vat.

The end effector may include a first clamp; a second clamp; a biasing device to bias the first clamp and the second clamp in an opened position; a drive mechanism to move the first clamp and the second clamp together; and a rotation mechanism to rotate the first clamp and the second clamp.

The delaminating food dispensing system may include an outer housing; and a delaminating housing; the delaminating housing having a first portion being located within the outer housing and a second portion located outside the outer housing; the delaminating housing including, delaminating nips, a first film take-up roller, a second film take-up roller, an output opening, and a trap void; the output opening being located in the second portion of the delaminating housing.

The method may move vertically, using the vertical drive unit, the end effector to a position for grasping the fry basket hooked on the fry unit above the fry vat.

The first direction may be clockwise. The first direction may be counter-clockwise.

The method may rotate in a second direction, using the end effector, the empty fry basket after rotating the fry basket to unload the cooked food product into the cooked food product staging unit, the second direction being counter-clockwise.

The method may rotate in a second direction, using the end effector, the empty fry basket after rotating the fry basket to unload the cooked food product into the cooked food product staging unit, the second direction being clockwise.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above.

What is claimed is:

1. An automatic fryer system comprising:
a fry basket;
a fryer unit having a fry vat for housing heated cooking oil and receiving said fry basket;
said fryer unit including a rear wall having a fry basket hooking member located thereon for parking said fry basket;
a horizontal drive system for moving said fry basket in a horizontal direction;
a vertical drive system, operatively connected to said horizontal drive system, for moving said fry basket in a vertical direction;
an end effector for grasping and holding said fry basket;
a food product loading unit for loading food product into said fry basket; and
a controller, in operational communication with said horizontal drive system; said vertical drive system, and said end effector, to control a location and an orientation of said fry basket.

2. The automatic fryer system as claimed in claim 1, wherein said controller controls said horizontal drive system to move said fry basket from a first location associated with said fryer unit to a second location associated with said food product loading unit and to move said fry basket from said second location associated with said food product loading unit to said first location associated with said fryer unit.

3. The automatic fryer system as claimed in claim 1, further comprising a fried product staging unit.

4. The automatic fryer system as claimed in claim 3, wherein said controller controls said horizontal drive system to move said fry basket from associated with said fryer unit to a third location associated with said fried product staging unit.

5. The automatic fryer system as claimed in claim 4, wherein said fryer basket has a closed end and an open end;
said controller, when said fry basket is located at said third location associated with said fried product staging unit, controlling said end effector to rotate said fry basket such that the open end of said fry basket is orientated, with respect to said fried product staging unit, to facilitate unloading of food product from said fry basket into said fried product staging unit.

6. The automatic fryer system as claimed in claim 1, wherein said controller controls said vertical drive system to move said fry basket from a third location above said fry vat of said fryer unit to a fourth location within said fry vat of said fryer unit and to move said fry basket from said fourth location within said fry vat of said fryer unit to said third location above said fry vat of said fryer unit.

7. The automatic fryer system as claimed in claim 1, wherein said end effector comprises:
a first clamp;
a second clamp;
a biasing device to bias said first clamp and said second clamp in an opened position;
a drive mechanism to move said first clamp and said second clamp together; and
a rotation mechanism to rotate said first clamp and said second clamp.

8. The automatic fryer system as claimed in claim 7, wherein said first clamp includes a first shaped engagement end member and said second clamp includes a second shaped engagement end member.

9. The automatic fryer system as claimed in claim 8, wherein said first shaped engagement end member has a shape to match a first indentation in said fry basket and said second shaped engagement end member has a shape to match a second indentation in said fry basket.

10. The automatic fryer system as claimed in claim 7, wherein said biasing device is a spring.

11. The automatic fryer system as claimed in claim 7, wherein said drive mechanism is a motorized take-up reel on said first clamp and a wire connected to said second clamp and said motorized take-up reel.

12. The automatic fryer system as claimed in claim 1, further comprising:
an enclosure;
said enclosure including,
an intake vent opening for removing vapors, smoke, gases, produced by said fryer unit station,
a fan/catalytic converter system, pneumatically connected to said intake vent opening, to combust the vapors, smoke, gases drawn from said fryer unit station to create an exhaust gas that can be properly expelled to the ambient environment, and
an outlet vent, pneumatically connected to said fan/catalytic converter system, to expel the combusted gas to the ambient environment.

13. The automatic fryer system as claimed in claim 1, wherein said food product loading unit is a delaminating food dispensing system comprising:
an outer housing; and
a delaminating housing;
said delaminating housing having a first portion being located within said outer housing and a second portion located outside said outer housing;
said delaminating housing including,
delaminating nips,
a first film take-up roller,
a second film take-up roller,
an output opening, and
a trap void;
said output opening being located in said second portion of said delaminating housing.

14. An end effector for grasping a fry basket, comprising:
a first clamp;
a second clamp;
a biasing device to bias said first clamp and said second clamp in an opened position;
a drive mechanism to move said first clamp and said second clamp together; and
a rotation mechanism to rotate said first clamp and said second clamp.

15. The end effector as claimed in claim 14, wherein said first clamp includes a first shaped engagement end member and said second clamp includes a second shaped engagement end member.

16. The end effector as claimed in claim 15, wherein said first shaped engagement end member has a shape to match a first indentation in said fry basket and said second shaped engagement end member has a shape to match a second indentation in said fry basket.

17. The end effector as claimed in claim 15, wherein said first shaped engagement end member has a shape to match a first projection on said fry basket and said second shaped engagement end member has a shape to match a second projection on said fry basket.

18. The end effector as claimed in claim 14, wherein said biasing device is a spring.

19. The end effector as claimed in claim 14, wherein said drive mechanism is a motorized take-up reel on said first clamp and a wire connected to said second clamp and said motorized take-up reel.
